(19) United States
(12) Patent Application Publication
(10) Pub. No.: US 2021/0153516 A1
(43) Pub. Date: May 27, 2021

(54) COMPOSITION AND METHOD OF TREATING PLANTS AND PLANT PARTS WITH VOLATILE SPOILAGE ORGANISM CONTROLLING ACTIVES

(71) Applicant: AGROFRESH INC., Philadelphia, PA (US)

(72) Inventors: Daniel MACLEAN, Geneva, NY (US); Lei LIU, Lansdale, PA (US); Alistair MCKAY, Clovis, CA (US); Elena RONDELLI, Bologna (IT); Andres LOPEZ, Valencia (ES)

(21) Appl. No.: 16/953,877

(22) Filed: Nov. 20, 2020

Related U.S. Application Data
(60) Provisional application No. 62/939,051, filed on Nov. 22, 2019.

(51) Int. Cl. A23B 7/154; A01N 55/08; A01N 25/06

(52) U.S. Cl. CPC A23B 7/154; A01N 25/06; A01N 55/08

(57) ABSTRACT

The present disclosure provides compositions and methods to promote improved delivery of volatile compounds to produce. As a result, the present disclosure provides more efficient and uniform delivery of volatile compounds and more effective control of spoilage organisms located on or near the stored produce.

### CROSS REFERENCE

This application claims the benefit under 35 USC § 119(e) of U.S. Provisional Application Ser. No. 62/939,051, filed on Nov. 22, 2019, the entire disclosure of which is incorporated herein by reference.

### TECHNICAL FIELD

The invention relates to agricultural formulations comprising a volatile compound. The invention includes methods of applying the volatile compound to a target produce, including delivery of the volatile compound and redistribution of the volatile compound.

### BACKGROUND AND SUMMARY OF THE INVENTION

The treatment of produce, including both plants and plant parts, in order to prevent or delay their spoilage is an important requirement in the agricultural sector. Avoidance of spoilage not only allows for maximizing consumption of the produce but also prevents unnecessary waste of the produce. It is customary to treat produce with anti-spoilage compounds on a bulk scale, such as the treatment of large areas containing multiple storage containers of the produce.

However, such bulk scale delivery is often inefficient using current formulations and methods. For instance, the amount of anti-spoilage compounds that is actually delivered to the produce is very low in comparison to the amount of the compounds that are administered a large area. This inefficiency occurs when anti-spoilage compounds are administered to an entire area but a minimal percentage of the anti-spoilage active ingredient actually contacts the produce to be protected. Furthermore, the active ingredient that does contact the produce is not uniformly delivered to the multiple locations of stored produce, thus potentially resulting in inconsistent protection from spoilage within a single storage container. Thus, there exists a need to improve the bulk scale delivery of anti-spoilage compounds such as volatile compounds in order to improve efficacy and reduce waste during treatment of produce.

The present disclosure provides compositions and methods to promote improved delivery of volatile compounds to produce. Without being bound by any theory, it is hypothesized that delivery can be improved by controlling the primary delivery and the secondary delivery of volatile compounds within a general area of produce. As a result, the present disclosure provides more uniform delivery of volatile compounds and more effective control of spoilage organisms located on or near the stored produce.

The primary delivery of volatile compounds can be achieved via conventional application methods, sometimes referred to as “long range” applications. For example, such conventional application methods include fogging, spraying, drenching, dipping, and the like. These conventional application methods typically provide delivery of the volatile compounds in the vicinity of the produce to be treated.

Thereafter, secondary delivery of the volatile compounds can be achieved via redistribution of the compounds deposited during the primary delivery. For instance, relocation of the volatile compounds can occur via vapor action or vapor movement such as revaporization of the compound from the primary delivery location. This vapor action or vapor movement can take place within an enclosed or partially enclosed space to more effectively deliver the volatile compounds to the target produce.

The compositions and methods of the present disclosure provide one or more facets to accomplish the stated goals. In some embodiments, the compositions and methods include certain “enhancers” in the formulations of the volatile compounds in order to allow for more control of the speed and coverage of the primary delivery and secondary redistribution to achieve the optimal anti-spoilage performance for a given application. In various embodiments, an appropriate vapor pressure of the volatile compounds may be utilized to maximize the efficiency of the disclosed formulations. Furthermore, the particle size and distribution of the atomization process of a conventional application method containing the volatile compounds may be tailored according to the present disclosure, for instance to provide easier release of the volatile compound from the primary delivery methods.

Moreover, the distance between the first location of the primary delivery and the second location of the secondary delivery may be optimized to improve the efficacy of the volatile compounds. These improvements may enhance delivery to the enclosed or partially enclosed space containing the produce to be treated. In some embodiments, improvements in efficacy can be observed by optimizing the accessible surface area ratio of the second location in comparison to the first location.

The following numbered embodiments are contemplated and are non-limiting:
1. A method of applying a volatile compound to a target produce, said method comprising the steps of:
   A. delivering a formulation comprising the volatile compound to a first location, and thereafter
   B. redistributing the volatile compound from the first location to a second location.
2. The method of clause 1, any other suitable clause, or any combination of suitable clauses, wherein the step of delivering is selected from the group consisting of spraying, misting, thermal or non-thermal fogging, drenching, dipping, submersing, and combinations thereof.
3. The method of clause 1, any other suitable clause, or any combination of suitable clauses, wherein the step of delivering comprises spraying.
4. The method of clause 3, any other suitable clause, or any combination of suitable clauses, wherein the spraying is selected from the group consisting of electrostatic spraying, electrospraying, pneumatic air spraying, compressed air spraying, ultrasonic air spraying, air assisted ultrasonic air spraying, and combinations thereof.
5. The method of clause 3 or clause 4, any other suitable clause, or any combination of suitable clauses, wherein the spraying produces a droplet size of the formulation between about 0.01 μm to about 1 cm.
6. The method of clause 3 or clause 4, any other suitable clause, or any combination of suitable clauses, wherein the spraying produces a droplet size of the formulation between about 0.01 μm to about 1000 μm.
7. The method of clause 3 or clause 4, any other suitable clause, or any combination of suitable clauses, wherein the spraying produces a droplet size of the formulation between about 0.01 μm to about 100 μm.
8. The method of clause 3 or clause 4, any other suitable clause, or any combination of suitable clauses, wherein the spraying produces a droplet size of the formulation between about 0.1 μm to about 1000 μm.
9. The method of clause 3 or clause 4, any other suitable clause, or any combination of suitable clauses, wherein the spraying produces a droplet size of the formulation between about 0.1 μm to about 100 μm.
10. The method of clause 3 or clause 4, any other suitable clause, or any combination of suitable clauses, wherein the spraying produces a droplet size of the formulation between about 1 μm to about 1000 μm.
11. The method of clause 3 or clause 4, any other suitable clause, or any combination of suitable clauses, wherein the spraying produces a droplet size of the formulation between about 1 μm to about 100 μm.
12. The method of clause 3 or clause 4, any other suitable clause, or any combination of suitable clauses, wherein the spraying produces a droplet size of the formulation between about 1 μm to about 10 μm.
13. The method of clause 1, any other suitable clause, or any combination of suitable clauses, wherein the step of delivering comprises fogging.
14. The method of clause 13, any other suitable clause, or any combination of suitable clauses, wherein the fogging is selected from the group consisting of thermo fogging, thermal fogging, cold fogging, nebulizing, misting, air brushing, and combinations thereof.
15. The method of clause 13 or clause 14, any other suitable clause, or any combination of suitable clauses, wherein the fogging produces a droplet size of the formulation between about 0.01 μm to about 1000 μm.
16. The method of clause 13 or clause 14, any other suitable clause, or any combination of suitable clauses, wherein the fogging produces a droplet size of the formulation between about 0.01 μm to about 100 μm.
17. The method of clause 13 or clause 14, any other suitable clause, or any combination of suitable clauses, wherein the fogging produces a droplet size of the formulation between about 0.1 μm to about 1000 μm.
18. The method of clause 13 or clause 14, any other suitable clause, or any combination of suitable clauses, wherein the fogging produces a droplet size of the formulation between about 0.1 μm to about 100 μm.
19. The method of clause 13 or clause 14, any other suitable clause, or any combination of suitable clauses, wherein the fogging produces a droplet size of the formulation between about 1 μm to about 1000 μm.
20. The method of clause 13 or clause 14, any other suitable clause, or any combination of suitable clauses, wherein the fogging produces a droplet size of the formulation between about 1 μm to about 100 μm.
21. The method of clause 13 or clause 14, any other suitable clause, or any combination of suitable clauses, wherein the fogging produces a droplet size of the formulation between about 1 μm to about 10 μm.
22. The method of clause 1, any other suitable clause, or any combination of suitable clauses, wherein the step of delivering comprises a continuous liquid application.
23. The method of clause 22, any other suitable clause, or any combination of suitable clauses, wherein the continuous liquid application is selected from the group consisting of a drench, a dip, a submersion, a flooding, a curtain shower, and combinations thereof.
24. The method of any one of clauses 1 to 23, any other suitable clause, or any combination of suitable clauses, wherein the first location is a post-harvest processing facility.
25. The method of clause 24, any other suitable clause, or any combination of suitable clauses, wherein the post-harvest processing facility is a storage room.
26. The method of clause 24, any other suitable clause, or any combination of suitable clauses, wherein the post-harvest processing facility is a packing house.
27. The method of clause 24, any other suitable clause, or any combination of suitable clauses, wherein the post-harvest processing facility is a packing or sorting line.
28. The method of clause 24, any other suitable clause, or any combination of suitable clauses, wherein the post-harvest processing facility is a transit center.
29. The method of clause 24, any other suitable clause, or any combination of suitable clauses, wherein the post-harvest processing facility is a distribution center.
30. The method of clause 24, any other suitable clause, or any combination of suitable clauses, wherein the post-harvest processing facility is a field packing area.
31. The method of any one of clauses 1 to 30, any other suitable clause, or any combination of suitable clauses, wherein the first location is a composition located near the target produce.
32. The method of clause 31, any other suitable clause, or any combination of suitable clauses, wherein the composition located near the target produce is within about 1 meter of the target produce.
33. The method of any one of clauses 1 to 32, any other suitable clause, or any combination of suitable clauses, wherein the first location is selected from the group consisting of a package, a container, a pallet, a bin, a bag, a case, a clamshell, and a composition located near the target produce.
34. The method of any one of clauses 1 to 32, any other suitable clause, or any combination of suitable clauses, wherein the first location is a storage room.
35. The method of any one of clauses 1 to 32, any other suitable clause, or any combination of suitable clauses, wherein the first location is a package.
36. The method of any one of clauses 1 to 32, any other suitable clause, or any combination of suitable clauses, wherein the first location is a bin.
37. The method of any one of clauses 1 to 32, any other suitable clause, or any combination of suitable clauses, wherein the first location is a bag.
38. The method of any one of clauses 1 to 32, any other suitable clause, or any combination of suitable clauses, wherein the first location is a case.
39. The method of any one of clauses 1 to 32, any other suitable clause, or any combination of suitable clauses, wherein the first location is a clamshell.
40. The method of any one of clauses 1 to 39, any other suitable clause, or any combination of suitable clauses, wherein the second location is an enclosed space or a partially enclosed space.
41. The method of any one of clauses 1 to 40, any other suitable clause, or any combination of suitable clauses, wherein the second location is selected from the group consisting of a storage room, a package, a container, a pallet, a bin, a bag, a case, a clamshell, and a composition located near the target produce.
42. The method of any one of clauses 1 to 40, any other suitable clause, or any combination of suitable clauses, wherein the second location is a storage room.
43. The method of any one of clauses 1 to 40, any other suitable clause, or any combination of suitable clauses, wherein the second location is a package.
44. The method of any one of clauses 1 to 40, any other suitable clause, or any combination of suitable clauses, wherein the second location is a bin.
45. The method of any one of clauses 1 to 40, any other suitable clause, or any combination of suitable clauses, wherein the second location is a bag.
46. The method of any one of clauses 1 to 40, any other suitable clause, or any combination of suitable clauses, wherein the second location is a case.
47. The method of any one of clauses 1 to 40, any other suitable clause, or any combination of suitable clauses, wherein the second location is a clamshell.
48. The method of any one of clauses 1 to 47, any other suitable clause, or any combination of suitable clauses, wherein the second location is a composition located near the target produce.
49. The method of clause 48, any other suitable clause, or any combination of suitable clauses, wherein the composition located near the target produce is within about 1 meter of the target produce.
50. The method of any one of clauses 1 to 49, any other suitable clause, or any combination of suitable clauses, wherein the step of delivering provides the volatile compound to a first percentage of available surface area coverage and the step of redistributing provides the volatile compound to a second percentage of available surface area coverage that is greater than the first percentage of available surface area coverage.
51. The method of any one of clauses 1 to 50, any other suitable clause, or any combination of suitable clauses, wherein the formulation comprises the volatile compound at a vapor pressure of about 10⁻⁶ torr at 1 atm/25° C. to about 1 torr at 1 atm/25° C.
52. The method of any one of clauses 1 to 50, any other suitable clause, or any combination of suitable clauses, wherein the formulation comprises the volatile compound at a vapor pressure of about 10⁻⁶ torr at 1 atm/25° C. to about 10⁻¹ torr at 1 atm/25° C.
53. The method of any one of clauses 1 to 50, any other suitable clause, or any combination of suitable clauses, wherein the formulation comprises the volatile compound at a vapor pressure of about 10⁻⁶ torr at 1 atm/25° C. to about 10⁻² torr at 1 atm/25° C.
54. The method of any one of clauses 1 to 50, any other suitable clause, or any combination of suitable clauses, wherein the formulation comprises the volatile compound at a vapor pressure of about 10⁻⁶ torr at 1 atm/25° C. to about 10⁻³ torr at 1 atm/25° C.
55. The method of any one of clauses 1 to 50, any other suitable clause, or any combination of suitable clauses, wherein the formulation comprises the volatile compound at a vapor pressure of about 10⁻⁵ torr at 1 atm/25° C. to about 10⁻³ torr at 1 atm/25° C.
56. The method of any one of clauses 1 to 50, any other suitable clause, or any combination of suitable clauses, wherein the formulation comprises the volatile compound at a vapor pressure of about 10⁻⁵ torr at 1 atm/25° C. to about 10-torr at 1 atm/25° C.
57. The method of any one of clauses 1 to 50, any other suitable clause, or any combination of suitable clauses, wherein the formulation comprises the volatile compound at a vapor pressure of about 10⁻⁴ torr at 1 atm/25° C. to about 10⁻³ torr at 1 atm/25° C.
58. The method of any one of clauses 1 to 50, any other suitable clause, or any combination of suitable clauses, wherein the formulation comprises the volatile compound at a vapor pressure of about 10⁻⁶ torr at 1 atm/25° C. to about 10⁻⁵ torr at 1 atm/25° C.
59. The method of any one of clauses 1 to 50, any other suitable clause, or any combination of suitable clauses, wherein the formulation comprises the volatile compound at a vapor pressure of about 10⁻³ torr at 1 atm/25° C.
60. The method of any one of clauses 1 to 50, any other suitable clause, or any combination of suitable clauses, wherein the formulation comprises the volatile compound at a vapor pressure of about 10⁻⁴ torr at 1 atm/25° C.
61. The method of any one of clauses 1 to 50, any other suitable clause, or any combination of suitable clauses, wherein the formulation comprises the volatile compound at a vapor pressure of about 10⁻⁵ torr at 1 atm/25° C.
62. The method of any one of clauses 1 to 50, any other suitable clause, or any combination of suitable clauses, wherein the formulation comprises the volatile compound at a vapor pressure of about 1.65×10⁻⁶ torr at 1 atm/25° C.
63. The method of any one of clauses 1 to 50, any other suitable clause, or any combination of suitable clauses, wherein the formulation comprises the volatile compound at a vapor pressure of about 10⁻⁶ torr at 1 atm/25° C.
64. The method of any one of clauses 1 to 50, any other suitable clause, or any combination of suitable clauses, wherein the formulation comprises the volatile compound at a vapor pressure of about 3.25×10⁻³ torr at 1 atm/25° C.
65. The method of any one of clauses 1 to 50, any other suitable clause, or any combination of suitable clauses, wherein the formulation comprises the volatile compound at a vapor pressure of about 3×10⁻³ torr at 1 atm/25° C.
66. The method of any one of clauses 1 to 65, any other suitable clause, or any combination of suitable clauses, wherein the volatile compound comprises a volatile antimicrobial compound against pathogens affecting meats, plants, or plant parts.
67. The method of any one of clauses 1 to 66, any other suitable clause, or any combination of suitable clauses, wherein the target produce is a plant or a plant part.
68. The method of any one of clauses 1 to 67, any other suitable clause, or any combination of suitable clauses, wherein the partially enclosed space is between about 50% to 100% enclosed from an outside environment.
69. The method of any one of clauses 1 to 67, any other suitable clause, or any combination of suitable clauses, wherein the partially enclosed space is between about 60% to 100% enclosed from an outside environment.
70. The method of any one of clauses 1 to 67, any other suitable clause, or any combination of suitable clauses, wherein the partially enclosed space is between about 70% to 100% enclosed from an outside environment.
71. The method of any one of clauses 1 to 67, any other suitable clause, or any combination of suitable clauses, wherein the partially enclosed space is between about 70% to 90% enclosed from an outside environment.
72. The method of any one of clauses 1 to 71, any other suitable clause, or any combination of suitable clauses, wherein the formulation is a non-aqueous soluble liquid.
73. The method of any one of clauses 1 to 71, any other suitable clause, or any combination of suitable clauses, wherein the formulation is an aqueous soluble liquid.
74. The method of any one of clauses 1 to 71, any other suitable clause, or any combination of suitable clauses, wherein the formulation is a suspension or dispersion of the volatile compound in liquid media.
75. The method of any one of clauses 1 to 74, any other suitable clause, or any combination of suitable clauses, wherein the distance between the first location and the second location is between about 0.001 meter to about 1 meter.
76. The method of any one of clauses 1 to 74, any other suitable clause, or any combination of suitable clauses, wherein the distance between the first location and the second location is between about 0.01 meter to about 1 meter.
77. The method of any one of clauses 1 to 74, any other suitable clause, or any combination of suitable clauses, wherein the distance between the first location and the second location is between about 0.1 meter to about 1 meter.
78. The method of any one of clauses 1 to 77, any other suitable clause, or any combination of suitable clauses, wherein the volatile compound is a benzoxaborole.
79. The method of any one of clauses 1 to 78, any other suitable clause, or any combination of suitable clauses, wherein the volatile compound has a structure of formula (VI):

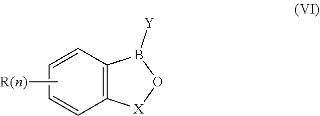

wherein each R is independently hydrogen, alkyl, alkene, alkyne, haloalkyl, haloalkene, haloalkyne, alkoxy, alkeneoxy, haloalkoxy, aryl, heteroaryl, arylalkyl, arylalkene, arylalkyne, heteroarylalkyl, heteroarylalkene, heteroarylalkyne, halogen, hydroxyl, nitrile, amine, ester, carboxylic acid, ketone, alcohol, sulfide, sulfoxide, sulfone, sulfoximine, sulfilimine, sulfonamide, sulfate, sulfonate, nitroalkyl, amide, oxime, imine, hydroxylamine, hydrazine, hydrazone, carbamate, thiocarbamate, urea, thiourea, carbonate, aryloxy, or heteroaryloxy;
n=1, 2, 3, or 4;
B is boron;
X═(CR₂)ₘ where m=1, 2, 3, or 4;
Y is alkyl, alkene, alkyne, haloalkyl, haloalkene, haloalkyne, alkoxy, alkeneoxy, haloalkoxy, aryl, heteroaryl, arylalkyl, arylalkene, arylalkyne, heteroarylalkyl, heteroarylalkene, heteroarylalkyne, hydroxyl, nitrile, amine, ester, carboxylic acid, ketone, alcohol, sulfide, sulfoxide, sulfone, sulfoximine, sulfilimine, sulfonamide, sulfate, sulfonate, nitroalkyl, amide, oxime, imine, hydroxylamine, hydrazine, hydrazone, carbamate, thiocarbamate, urea, thiourea, carbonate, aryloxy, or heteroaryloxy;
with a proviso that R is not aryloxy or heteroaryloxy when Y is hydroxyl;
and pharmaceutically or agriculturally acceptable salts thereof.
80. The method of any one of clauses 1 to 79, any other suitable clause, or any combination of suitable clauses, wherein the volatile compound has a structure of

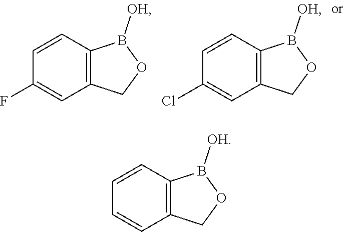

81. The method of any one of clauses 1 to 80, any other suitable clause, or any combination of suitable clauses, wherein the volatile compound has a structure of formula (A1) or (A2):

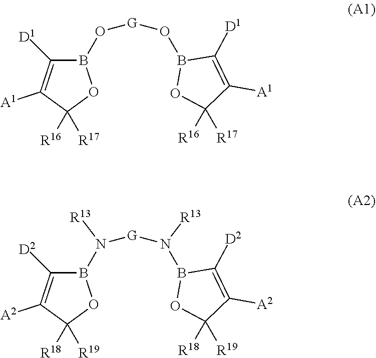

wherein each of A1, A2, D1, and D2 is independently hydrogen, substituted or unsubstituted C1-18-alkyl, arylalkyl, aryl, or heterocyclic; or Aland D1, or A2 and D2 together form a 5, 6, or 7-membered fused ring which is substituted or unsubstituted;
each of R13, R16, R17, R18, and R19 is independently hydrogen, substituted or unsubstituted C1-6-alkyl, nitrile, nitro, aryl or aryl alkyl; or R16 and R17, or R18 and R19 together form an alicyclic ring which is substituted or unsubstituted;
B is boron;
G is a substituted or unsubstituted C1-18-alkylene, arylalkylene, arylene, or heterocyclic moiety;
and pharmaceutically or agriculturally acceptable salts thereof.
82. The method of any one of clauses 1 to 81, any other suitable clause, or any combination of suitable clauses, wherein each of R^{A} and R^{B} is independently

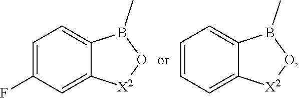

wherein X²═(CR⁶₂)ₘ and m=1, 2, 3, or 4.
83. The method of any one of clauses 1 to 82, any other suitable clause, or any combination of suitable clauses, wherein the volatile compound has a structure of

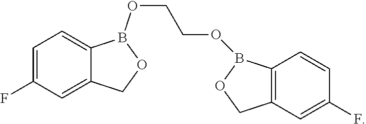 [SMILES: Fc1ccc2c(c1)COB2OCCOB1OCc2cc(F)ccc21]

84. The method of any one of clauses 1 to 83, any other suitable clause, or any combination of suitable clauses, wherein the volatile compound is present in the formulation at a concentration of about 0.001% to about 1%.
85. The method of any one of clauses 1 to 83, any other suitable clause, or any combination of suitable clauses, wherein the volatile compound is present in the formulation at a concentration of about 0.01% to about 0.1%.
86. The method of any one of clauses 1 to 83, any other suitable clause, or any combination of suitable clauses, wherein the volatile compound is present in the formulation at a concentration of about 0.02% to about 0.1%.
87. The method of any one of clauses 1 to 83, any other suitable clause, or any combination of suitable clauses, wherein the volatile compound is present in the formulation at a concentration of about 1% to about 10%.
88. The method of any one of clauses 1 to 83, any other suitable clause, or any combination of suitable clauses, wherein the volatile compound is present in the formulation at a concentration of about 10% to about 30%.
89. The method of any one of clauses 1 to 83, any other suitable clause, or any combination of suitable clauses, wherein the volatile compound is present in the formulation at a concentration of about 10% to about 60%.
90. The method of any one of clauses 1 to 83, any other suitable clause, or any combination of suitable clauses, wherein the volatile compound is present in the formulation at a concentration of about 30% to about 60%.
91. The method of any one of clauses 1 to 90, any other suitable clause, or any combination of suitable clauses, wherein the formulation comprises one or more solvents, liquid carriers, liquid media, or any combination thereof.
92. The method of clause 91, any other suitable clause, or any combination of suitable clauses, wherein the one or more solvents, liquid carriers, and liquid media is an alcohol.
93. The method of clause 91, any other suitable clause, or any combination of suitable clauses, wherein the one or more solvents, liquid carriers, and liquid media are selected from the group consisting of a glycol, a polyglycol, or combinations thereof.
94. The method of clause 91, any other suitable clause, or any combination of suitable clauses, wherein the one or more solvents, liquid carriers, and liquid media are selected from the group consisting of glycerin, polyols, sugars, water, and any combination thereof.
95. The method of any one of clauses 1 to 94, any other suitable clause, or any combination of suitable clauses, wherein the formulation comprises one or more enhancing agents.
96. The method of clause 95, any other suitable clause, or any combination of suitable clauses, wherein the enhancing agents are selected from the group consisting of a spreading agent, an adhesion agent, a surfactant, a stabilizer, a surface tension reducing agent, a dynamic surface tension reducing agent, a rheology modifying agent, and any combination thereof.
97. The method of any one of clauses 1 to 96, any other suitable clause, or any combination of suitable clauses, wherein the formulation comprises one or more release modifiers.
98. The method of clause 97, any other suitable clause, or any combination of suitable clauses, wherein the release modifiers are selected from the group consisting of a thickener, a gellant, a polymer, and combinations thereof.
99. The method of any one of clauses 1 to 98, any other suitable clause, or any combination of suitable clauses, wherein the volatile compound is more uniformly distributed after the step of redistribution.
100. The method of clause 99, any other suitable clause, or any combination of suitable clauses, wherein the uniform distribution is on a surface of the target produce.
101. The method of clause 99 or clause 100, any other suitable clause, or any combination of suitable clauses, wherein the uniform distribution is identified via residue analysis of the volatile compound.
102. The method of any one of clauses 1 to 101, any other suitable clause, or any combination of suitable clauses, wherein the volatile component comprises a first concentration at the first location and a second concentration at the second location, wherein the second concentration is lower than the first concentration.
103. The method of any one of clauses 1 to 102, any other suitable clause, or any combination of suitable clauses, wherein the step of delivering provides the volatile component at a first mass transfer rate and the step of redistributing provides the volatile component at a second mass transfer rate, wherein the second mass transfer rate is slower than the first mass transfer rate.
104. A method of applying a volatile compound to a target produce, said method comprising the steps of:
   A. delivering a formulation comprising the volatile compound to a first location, and thereafter
   B. redistributing the volatile compound from the first location to a second location, wherein the second location is on a surface of the target produce.
105. The method of clause 104, any other suitable clause, or any combination of suitable clauses, wherein the step of delivering is selected from the group consisting of spraying, misting, thermal or non-thermal fogging, drenching, dipping, submersing, and combinations thereof.
106. The method of clause 104, any other suitable clause, or any combination of suitable clauses, wherein the step of delivering comprises spraying.
107. The method of clause 106, any other suitable clause, or any combination of suitable clauses, wherein the spraying is selected from the group consisting of electrostatic spraying, electrospraying, pneumatic air spraying, compressed air spraying, ultrasonic air spraying, air assisted ultrasonic air spraying, and combinations thereof.
108. The method of clause 106 or clause 107, any other suitable clause, or any combination of suitable clauses, wherein the spraying produces a droplet size of the formulation between about 0.01 μm to about 1 cm.
109. The method of clause 106 or clause 107, any other suitable clause, or any combination of suitable clauses, wherein the spraying produces a droplet size of the formulation between about 0.01 μm to about 1000 μm.
110. The method of clause 106 or clause 107, any other suitable clause, or any combination of suitable clauses, wherein the spraying produces a droplet size of the formulation between about 0.01 μm to about 100 μm.
111. The method of clause 106 or clause 107, any other suitable clause, or any combination of suitable clauses, wherein the spraying produces a droplet size of the formulation between about 0.1 μm to about 1000 μm.
112. The method of clause 106 or clause 107, any other suitable clause, or any combination of suitable clauses, wherein the spraying produces a droplet size of the formulation between about 0.1 μm to about 100 μm.
113. The method of clause 106 or clause 107, any other suitable clause, or any combination of suitable clauses, wherein the spraying produces a droplet size of the formulation between about 1 μm to about 1000 μm.
114. The method of clause 106 or clause 107, any other suitable clause, or any combination of suitable clauses, wherein the spraying produces a droplet size of the formulation between about 1 μm to about 100 μm.
115. The method of clause 106 or clause 107, any other suitable clause, or any combination of suitable clauses, wherein the spraying produces a droplet size of the formulation between about 1 μm to about 10 μm.
116. The method of clause 104, any other suitable clause, or any combination of suitable clauses, wherein the step of delivering comprises fogging.
117. The method of clause 116, any other suitable clause, or any combination of suitable clauses, wherein the fogging is selected from the group consisting of thermo fogging, thermal fogging, cold fogging, nebulizing, misting, air brushing, and combinations thereof.
118. The method of clause 116 or clause 117, any other suitable clause, or any combination of suitable clauses, wherein the fogging produces a droplet size of the formulation between about 0.01 μm to about 1000 μm.
119. The method of clause 116 or clause 117, any other suitable clause, or any combination of suitable clauses, wherein the fogging produces a droplet size of the formulation between about 0.01 μm to about 100 μm.
120. The method of clause 116 or clause 117, any other suitable clause, or any combination of suitable clauses, wherein the fogging produces a droplet size of the formulation between about 0.1 μm to about 1000 μm.
121. The method of clause 116 or clause 117, any other suitable clause, or any combination of suitable clauses, wherein the fogging produces a droplet size of the formulation between about 0.1 μm to about 100 μm.
122. The method of clause 116 or clause 117, any other suitable clause, or any combination of suitable clauses, wherein the fogging produces a droplet size of the formulation between about 1 μm to about 1000 μm.
123. The method of clause 116 or clause 117, any other suitable clause, or any combination of suitable clauses, wherein the fogging produces a droplet size of the formulation between about 1 μm to about 100 μm.
124. The method of clause 116 or clause 117, any other suitable clause, or any combination of suitable clauses, wherein the fogging produces a droplet size of the formulation between about 1 μm to about 10 μm.
125. The method of clause 104, any other suitable clause, or any combination of suitable clauses, wherein the step of delivering comprises a continuous liquid application.
126. The method of clause 125, any other suitable clause, or any combination of suitable clauses, wherein the continuous liquid application is selected from the group consisting of a drench, a dip, a submersion, a flooding, a curtain shower, and combinations thereof.
127. The method of any one of clauses 104 to 126, any other suitable clause, or any combination of suitable clauses, wherein the first location is selected from the group consisting of a storage room, a package, a container, a pallet, a bin, a bag, a case, a clamshell, and a composition located near the target produce.
128. The method of any one of clauses 104 to 126, any other suitable clause, or any combination of suitable clauses, wherein the first location is a storage room.
129. The method of any one of clauses 104 to 126, any other suitable clause, or any combination of suitable clauses, wherein the first location is a package.
130. The method of any one of clauses 104 to 126, any other suitable clause, or any combination of suitable clauses, wherein the first location is a bin.
131. The method of any one of clauses 104 to 126, any other suitable clause, or any combination of suitable clauses, wherein the first location is a bag.
132. The method of any one of clauses 104 to 126, any other suitable clause, or any combination of suitable clauses, wherein the first location is a case.
133. The method of any one of clauses 104 to 126, any other suitable clause, or any combination of suitable clauses, wherein the first location is a clamshell.
134. The method of any one of clauses 104 to 133, any other suitable clause, or any combination of suitable clauses, wherein the first location is a composition located near the target produce.
135. The method of clause 134, any other suitable clause, or any combination of suitable clauses, wherein the composition located near the target produce is within about 1 meter of the target produce.
136. The method of any one of clauses 104 to 135, any other suitable clause, or any combination of suitable clauses, wherein the step of delivering provides the volatile compound to a first percentage of available surface area coverage and the step of redistributing provides the volatile compound to a second percentage of available surface area coverage that is greater than the first percentage of available surface area coverage.
137. The method of any one of clauses 104 to 136, any other suitable clause, or any combination of suitable clauses, wherein the formulation comprises the volatile compound at a vapor pressure of about 10⁻⁶ torr at 1 atm/25° C. to about 1 torr at 1 atm/25° C.
138. The method of any one of clauses 104 to 136, any other suitable clause, or any combination of suitable clauses, wherein the formulation comprises the volatile compound at a vapor pressure of about 10⁻⁶ torr at 1 atm/25° C. to about 10⁻¹ torr at 1 atm/25° C.
139. The method of any one of clauses 104 to 136, any other suitable clause, or any combination of suitable clauses, wherein the formulation comprises the volatile compound at a vapor pressure of about 10⁻⁶ torr at 1 atm/25° C. to about 10⁻² torr at 1 atm/25° C.
140. The method of any one of clauses 104 to 136, any other suitable clause, or any combination of suitable clauses, wherein the formulation comprises the volatile compound at a vapor pressure of about 10⁻⁶ torr at 1 atm/25° C. to about 10⁻³ torr at 1 atm/25° C.
141. The method of any one of clauses 104 to 136, any other suitable clause, or any combination of suitable clauses, wherein the formulation comprises the volatile compound at a vapor pressure of about 10⁻⁵ torr at 1 atm/25° C. to about 10⁻³ torr at 1 atm/25° C.
142. The method of any one of clauses 104 to 136, any other suitable clause, or any combination of suitable clauses, wherein the formulation comprises the volatile compound at a vapor pressure of about 10⁻⁵ torr at 1 atm/25° C. to about 104 torr at 1 atm/25° C.
143. The method of any one of clauses 104 to 136, any other suitable clause, or any combination of suitable clauses, wherein the formulation comprises the volatile compound at a vapor pressure of about 10¹ torr at 1 atm/25° C. to about 10⁻³ torr at 1 atm/25° C.
144. The method of any one of clauses 104 to 136, any other suitable clause, or any combination of suitable clauses, wherein the formulation comprises the volatile compound at a vapor pressure of about 10⁻⁶ torr at 1 atm/25° C. to about 10⁻⁵ torr at 1 atm/25° C.
145. The method of any one of clauses 104 to 136, any other suitable clause, or any combination of suitable clauses, wherein the formulation comprises the volatile compound at a vapor pressure of about 10⁻³ torr at 1 atm/25° C.
146. The method of any one of clauses 104 to 136, any other suitable clause, or any combination of suitable clauses, wherein the formulation comprises the volatile compound at a vapor pressure of about 10⁻⁴ torr at 1 atm/25° C.
147. The method of any one of clauses 104 to 136, any other suitable clause, or any combination of suitable clauses, wherein the formulation comprises the volatile compound at a vapor pressure of about 10⁻⁵ torr at 1 atm/25° C.
148. The method of any one of clauses 104 to 136, any other suitable clause, or any combination of suitable clauses, wherein the formulation comprises the volatile compound at a vapor pressure of about 1.65×10⁻⁶ torr at 1 atm/25° C.
149. The method of any one of clauses 104 to 136, any other suitable clause, or any combination of suitable clauses, wherein the formulation comprises the volatile compound at a vapor pressure of about 10⁻⁶ torr at 1 atm/25° C.
150. The method of any one of clauses 104 to 136, any other suitable clause, or any combination of suitable clauses, wherein the formulation comprises the volatile compound at a vapor pressure of about 3.25×10⁻³ torr at 1 atm/25° C.
151. The method of any one of clauses 104 to 136, any other suitable clause, or any combination of suitable clauses, wherein the formulation comprises the volatile compound at a vapor pressure of about 3×10⁻³ torr at 1 atm/25° C.
152. The method of any one of clauses 104 to 151, any other suitable clause, or any combination of suitable clauses, wherein the volatile compound is a volatile antimicrobial compound against pathogens affecting meats, plants, or plant parts.
153. The method of any one of clauses 104 to 152, any other suitable clause, or any combination of suitable clauses, wherein the target produce is a plant or a plant part.
154. The method of any one of clauses 104 to 153, any other suitable clause, or any combination of suitable clauses, wherein the partially enclosed space is between about 50% to 100% enclosed from an outside environment.
155. The method of any one of clauses 104 to 153, any other suitable clause, or any combination of suitable clauses, wherein the partially enclosed space is between about 60% to 100% enclosed from an outside environment.
156. The method of any one of clauses 104 to 153, any other suitable clause, or any combination of suitable clauses, wherein the partially enclosed space is between about 70% to 100% enclosed from an outside environment.
157. The method of any one of clauses 104 to 153, any other suitable clause, or any combination of suitable clauses, wherein the partially enclosed space is between about 70% to 90% enclosed from an outside environment.
158. The method of any one of clauses 104 to 157, any other suitable clause, or any combination of suitable clauses, wherein the formulation is a non-aqueous soluble liquid.
159. The method of any one of clauses 104 to 157, any other suitable clause, or any combination of suitable clauses, wherein the formulation is an aqueous soluble liquid.
160. The method of any one of clauses 104 to 157, any other suitable clause, or any combination of suitable clauses, wherein the formulation is a suspension or dispersion of the volatile compound in liquid media.
161. The method of any one of clauses 104 to 160, any other suitable clause, or any combination of suitable clauses, wherein the distance between the first location and the second location is between about 0.001 meter to about 1 meter.
162. The method of any one of clauses 104 to 161, any other suitable clause, or any combination of suitable clauses, wherein the volatile compound is a benzoxaborole.
163. The method of any one of clauses 104 to 162, any other suitable clause, or any combination of suitable clauses, wherein the volatile compound has a structure of formula (VI):

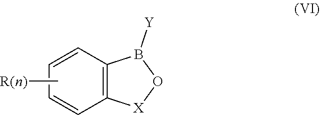

wherein each R is independently hydrogen, alkyl, alkene, alkyne, haloalkyl, haloalkene, haloalkyne, alkoxy, alkeneoxy, haloalkoxy, aryl, heteroaryl, arylalkyl, arylalkene, arylalkyne, heteroarylalkyl, heteroarylalkene, heteroarylalkyne, halogen, hydroxyl, nitrile, amine, ester, carboxylic acid, ketone, alcohol, sulfide, sulfoxide, sulfone, sulfoximine, sulfilimine, sulfonamide, sulfate, sulfonate, nitroalkyl, amide, oxime, imine, hydroxylamine, hydrazine, hydrazone, carbamate, thiocarbamate, urea, thiourea, carbonate, aryloxy, or heteroaryloxy;
n=1, 2, 3, or 4;
B is boron;
X═(CR₂)ₘ where m=1, 2, 3, or 4;
Y is alkyl, alkene, alkyne, haloalkyl, haloalkene, haloalkyne, alkoxy, alkeneoxy, haloalkoxy, aryl, heteroaryl, arylalkyl, arylalkene, arylalkyne, heteroarylalkyl, heteroarylalkene, heteroarylalkyne, hydroxyl, nitrile, amine, ester, carboxylic acid, ketone, alcohol, sulfide, sulfoxide, sulfone, sulfoximine, sulfilimine, sulfonamide, sulfate, sulfonate, nitroalkyl, amide, oxime, imine, hydroxylamine, hydrazine, hydrazone, carbamate, thiocarbamate, urea, thiourea, carbonate, aryloxy, or heteroaryloxy;
with a proviso that R is not aryloxy or heteroaryloxy when Y is hydroxyl;
and pharmaceutically or agriculturally acceptable salts thereof.
164. The method of any one of clauses 104 to 163, any other suitable clause, or any combination of suitable clauses, wherein the volatile compound has a structure of

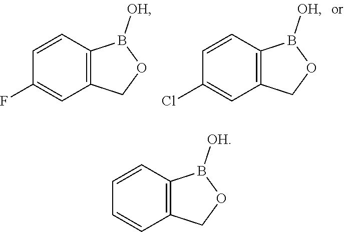

165. The method of any one of clauses 104 to 164, any other suitable clause, or any combination of suitable clauses, wherein the volatile compound has a structure of formula (A1) or (A2):

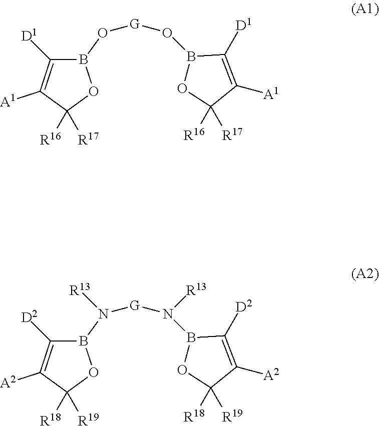

wherein each of A1, A2, D1, and D2 is independently hydrogen, substituted or unsubstituted C1-18-alkyl, arylalkyl, aryl, or heterocyclic; or A1 and D1, or A2 and D2 together form a 5, 6, or 7-membered fused ring which is substituted or unsubstituted;
each of R13, R16, R17, R18, and R19 is independently hydrogen, substituted or unsubstituted C1-6-alkyl, nitrile, nitro, aryl or aryl alkyl; or R16 and R17, or R18 and R19 together form an alicyclic ring which is substituted or unsubstituted;
B is boron;
G is a substituted or unsubstituted C1-18-alkylene, arylalkylene, arylene, or heterocyclic moiety;
and pharmaceutically or agriculturally acceptable salts thereof.
166. The method of any one of clauses 104 to 165, any other suitable clause, or any combination of suitable clauses, wherein each of R^{A} and R^{B} is independently

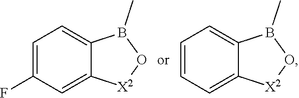

wherein X²═(CR⁶₂)ₘ and m=1, 2, 3, or 4.
167. The method of any one of clauses 104 to 166, any other suitable clause, or any combination of suitable clauses, wherein the volatile compound has a structure of

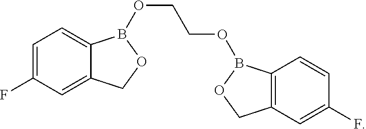 [SMILES: Fc1ccc2c(c1)COB2OCCOB1OCc2cc(F)ccc21]

168. The method of any one of clauses 104 to 167, any other suitable clause, or any combination of suitable clauses, wherein the volatile compound is present in the formulation at a concentration of about 0.001% to about 1%.
169. The method of any one of clauses 104 to 167, any other suitable clause, or any combination of suitable clauses, wherein the volatile compound is present in the formulation at a concentration of about 0.01% to about 0.1%.
170. The method of any one of clauses 104 to 167, any other suitable clause, or any combination of suitable clauses, wherein the volatile compound is present in the formulation at a concentration of about 0.02% to about 0.1%.
171. The method of any one of clauses 104 to 167, any other suitable clause, or any combination of suitable clauses, wherein the volatile compound is present in the formulation at a concentration of about 1% to about 10%.
172. The method of any one of clauses 104 to 167, any other suitable clause, or any combination of suitable clauses, wherein the volatile compound is present in the formulation at a concentration of about 10% to about 30%.
173. The method of any one of clauses 104 to 167, any other suitable clause, or any combination of suitable clauses, wherein the volatile compound is present in the formulation at a concentration of about 10% to about 60%.
174. The method of any one of clauses 104 to 167, any other suitable clause, or any combination of suitable clauses, wherein the volatile compound is present in the formulation at a concentration of about 30% to about 60%.
175. The method of any one of clauses 104 to 174, any other suitable clause, or any combination of suitable clauses, wherein the formulation comprises one or more solvents, liquid carriers, liquid media, or any combination thereof.
176. The method of clause 175, any other suitable clause, or any combination of suitable clauses, wherein the one or more solvents, liquid carriers, and liquid media is an alcohol.
177. The method of clause 175, any other suitable clause, or any combination of suitable clauses, wherein the one or more solvents, liquid carriers, and liquid media are selected from the group consisting of a glycol, a polyglycol, or combinations thereof
178. The method of clause 175, any other suitable clause, or any combination of suitable clauses, wherein the one or more solvents, liquid carriers, and liquid media are selected from the group consisting of glycerin, polyols, sugars, water, and any combination thereof.
179. The method of any one of clauses 104 to 178, any other suitable clause, or any combination of suitable clauses, wherein the formulation comprises one or more enhancing agents.
180. The method of clause 179, any other suitable clause, or any combination of suitable clauses, wherein the enhancing agents are selected from the group consisting of a spreading agent, an adhesion agent, a surfactant, a stabilizer, a surface tension reducing agent, a dynamic surface tension reducing agent, a rheology modifying agent, and any combination thereof.
181. The method of any one of clauses 104 to 180, any other suitable clause, or any combination of suitable clauses, wherein the formulation comprises one or more release modifiers.
182. The method of clause 181, any other suitable clause, or any combination of suitable clauses, wherein the release modifiers are selected from the group consisting of a thickener, a gellant, a polymer, and combinations thereof.
183. The method of any one of clauses 104 to 182, any other suitable clause, or any combination of suitable clauses, wherein the volatile compound is more uniformly distributed after the step of redistribution.
184. The method of clause 183, any other suitable clause, or any combination of suitable clauses, wherein the uniform distribution is on a surface of the target produce.
185. The method of clause 183 or clause 184, any other suitable clause, or any combination of suitable clauses, wherein the uniform distribution is identified via residue analysis of the volatile compound.
186. The method of any one of clauses 104 to 185, any other suitable clause, or any combination of suitable clauses, wherein the volatile component comprises a first concentration at the first location and a second concentration at the second location, wherein the second concentration is lower than the first concentration.
187. The method of any one of clauses 104 to 186, any other suitable clause, or any combination of suitable clauses, wherein the step of delivering provides the volatile component at a first mass transfer rate and the step of redistributing provides the volatile component at a second mass transfer rate, wherein the second mass transfer rate is slower than the first mass transfer rate.
188. A method of applying a volatile compound to a target produce, said method comprising the steps of:
   A. delivering a formulation comprising the volatile compound to a first location, wherein the first location is on a first surface of the target produce and thereafter
   B. redistributing the volatile compound from the first location to a second location, wherein the second location is on a second surface of the target produce.
189. The method of clause 188, any other suitable clause, or any combination of suitable clauses, wherein the step of delivering is selected from the group consisting of spraying, misting, thermal or non-thermal fogging, drenching, dipping, submersing, and combinations thereof.
190. The method of clause 188, any other suitable clause, or any combination of suitable clauses, wherein the step of delivering comprises spraying.
191. The method of clause 190, any other suitable clause, or any combination of suitable clauses, wherein the spraying is selected from the group consisting of electrostatic spraying, electrospraying, pneumatic air spraying, compressed air spraying, ultrasonic air spraying, air assisted ultrasonic air spraying, and combinations thereof.
192. The method of clause 190 or clause 191, any other suitable clause, or any combination of suitable clauses, wherein the spraying produces a droplet size of the formulation between about 0.01 μm to about 1 cm.
193. The method of clause 190 or clause 191, any other suitable clause, or any combination of suitable clauses, wherein the spraying produces a droplet size of the formulation between about 0.01 μm to about 1000 μm.
194. The method of clause 190 or clause 191, any other suitable clause, or any combination of suitable clauses, wherein the spraying produces a droplet size of the formulation between about 0.01 μm to about 100 μm.
195. The method of clause 190 or clause 191, any other suitable clause, or any combination of suitable clauses, wherein the spraying produces a droplet size of the formulation between about 0.1 μm to about 1000 μm.
196. The method of clause 190 or clause 191, any other suitable clause, or any combination of suitable clauses, wherein the spraying produces a droplet size of the formulation between about 0.1 μm to about 100 μm.
197. The method of clause 190 or clause 191, any other suitable clause, or any combination of suitable clauses, wherein the spraying produces a droplet size of the formulation between about 1 μm to about 1000 μm.
198. The method of clause 190 or clause 191, any other suitable clause, or any combination of suitable clauses, wherein the spraying produces a droplet size of the formulation between about 1 μm to about 100 μm.
199. The method of clause 190 or clause 191, any other suitable clause, or any combination of suitable clauses, wherein the spraying produces a droplet size of the formulation between about 1 μm to about 10 μm.
200. The method of clause 188, any other suitable clause, or any combination of suitable clauses, wherein the step of delivering comprises fogging.
201. The method of clause 200, any other suitable clause, or any combination of suitable clauses, wherein the fogging is selected from the group consisting of thermo fogging, thermal fogging, cold fogging, nebulizing, misting, air brushing, and combinations thereof.
202. The method of clause 200 or clause 201, any other suitable clause, or any combination of suitable clauses, wherein the fogging produces a droplet size of the formulation between about 0.01 μm to about 1000 μm.
203. The method of clause 200 or clause 201, any other suitable clause, or any combination of suitable clauses, wherein the fogging produces a droplet size of the formulation between about 0.01 μm to about 100 μm.
204. The method of clause 200 or clause 201, any other suitable clause, or any combination of suitable clauses, wherein the fogging produces a droplet size of the formulation between about 0.1 μm to about 1000 μm.
205. The method of clause 200 or clause 201, any other suitable clause, or any combination of suitable clauses, wherein the fogging produces a droplet size of the formulation between about 0.1 μm to about 100 μm.
206. The method of clause 200 or clause 201, any other suitable clause, or any combination of suitable clauses, wherein the fogging produces a droplet size of the formulation between about 1 μm to about 1000 μm.
207. The method of clause 200 or clause 201, any other suitable clause, or any combination of suitable clauses, wherein the fogging produces a droplet size of the formulation between about 1 μm to about 100 μm.
208. The method of clause 200 or clause 201, any other suitable clause, or any combination of suitable clauses, wherein the fogging produces a droplet size of the formulation between about 1 μm to about 10 μm.
209. The method of clause 188, any other suitable clause, or any combination of suitable clauses, wherein the step of delivering comprises a continuous liquid application.
210. The method of clause 209, any other suitable clause, or any combination of suitable clauses, wherein the continuous liquid application is selected from the group consisting of a drench, a dip, a submersion, a flooding, a curtain shower, and combinations thereof.
211. The method of any one of clauses 188 to 210, any other suitable clause, or any combination of suitable clauses, wherein the step of delivering provides the volatile compound to a first percentage of available surface area coverage and the step of redistributing provides the volatile compound to a second percentage of available surface area coverage that is greater than the first percentage of available surface area coverage.
212. The method of any one of clauses 188 to 211, any other suitable clause, or any combination of suitable clauses, wherein the formulation comprises the volatile compound at a vapor pressure of about 10⁻⁶ torr at 1 atm/25° C. to about 1 torr at 1 atm/25° C.
213. The method of any one of clauses 188 to 211, any other suitable clause, or any combination of suitable clauses, wherein the formulation comprises the volatile compound at a vapor pressure of about 10⁻⁶ torr at 1 atm/25° C. to about 10⁻¹ torr at 1 atm/25° C.
214. The method of any one of clauses 188 to 211, any other suitable clause, or any combination of suitable clauses, wherein the formulation comprises the volatile compound at a vapor pressure of about 10⁻⁶ torr at 1 atm/25° C. to about 10⁻² torr at 1 atm/25° C.
215. The method of any one of clauses 188 to 211, any other suitable clause, or any combination of suitable clauses, wherein the formulation comprises the volatile compound at a vapor pressure of about 10⁻⁶ torr at 1 atm/25° C. to about 10⁻³ torr at 1 atm/25° C.
216. The method of any one of clauses 188 to 211, any other suitable clause, or any combination of suitable clauses, wherein the formulation comprises the volatile compound at a vapor pressure of about 10⁻⁵ torr at 1 atm/25° C. to about 10⁻³ torr at 1 atm/25° C.
217. The method of any one of clauses 188 to 211, any other suitable clause, or any combination of suitable clauses, wherein the formulation comprises the volatile compound at a vapor pressure of about 10⁻⁵ torr at 1 atm/25° C. to about 10⁻⁴ torr at 1 atm/25° C.
218. The method of any one of clauses 188 to 211, any other suitable clause, or any combination of suitable clauses, wherein the formulation comprises the volatile compound at a vapor pressure of about 10⁻⁴ torr at 1 atm/25° C. to about 10⁻³ torr at 1 atm/25° C.
219. The method of any one of clauses 188 to 211, any other suitable clause, or any combination of suitable clauses, wherein the formulation comprises the volatile compound at a vapor pressure of about 10⁻⁶ torr at 1 atm/25° C. to about 10⁻⁵ torr at 1 atm/25° C.
220. The method of any one of clauses 188 to 211, any other suitable clause, or any combination of suitable clauses, wherein the formulation comprises the volatile compound at a vapor pressure of about 10⁻³ torr at 1 atm/25° C.
221. The method of any one of clauses 188 to 211, any other suitable clause, or any combination of suitable clauses, wherein the formulation comprises the volatile compound at a vapor pressure of about 10⁻⁴ torr at 1 atm/25° C.
222. The method of any one of clauses 188 to 211, any other suitable clause, or any combination of suitable clauses, wherein the formulation comprises the volatile compound at a vapor pressure of about 10⁻⁵ torr at 1 atm/25° C.
223. The method of any one of clauses 188 to 211, any other suitable clause, or any combination of suitable clauses, wherein the formulation comprises the volatile compound at a vapor pressure of about 1.65×10⁻⁶ torr at 1 atm/25° C.
224. The method of any one of clauses 188 to 211, any other suitable clause, or any combination of suitable clauses, wherein the formulation comprises the volatile compound at a vapor pressure of about 10⁻⁶ torr at 1 atm/25° C.
225. The method of any one of clauses 188 to 211, any other suitable clause, or any combination of suitable clauses, wherein the formulation comprises the volatile compound at a vapor pressure of about 3.25×10⁻³ torr at 1 atm/25° C.
226. The method of any one of clauses 188 to 211, any other suitable clause, or any combination of suitable clauses, wherein the formulation comprises the volatile compound at a vapor pressure of about 3×10⁻³ torr at 1 atm/25° C.
227. The method of any one of clauses 188 to 226, any other suitable clause, or any combination of suitable clauses, wherein the volatile compound is a volatile antimicrobial compound against pathogens affecting meats, plants, or plant parts.
228. The method of any one of clauses 188 to 227, any other suitable clause, or any combination of suitable clauses, wherein the target produce is a plant or a plant part.
229. The method of any one of clauses 188 to 228, any other suitable clause, or any combination of suitable clauses, wherein the partially enclosed space is between about 50% to 100% enclosed from an outside environment.
230. The method of any one of clauses 188 to 228, any other suitable clause, or any combination of suitable clauses, wherein the partially enclosed space is between about 60% to 100% enclosed from an outside environment.
231. The method of any one of clauses 188 to 228, any other suitable clause, or any combination of suitable clauses, wherein the partially enclosed space is between about 70% to 100% enclosed from an outside environment.
232. The method of any one of clauses 188 to 228, any other suitable clause, or any combination of suitable clauses, wherein the partially enclosed space is between about 70% to 90% enclosed from an outside environment.
233. The method of any one of clauses 188 to 232, any other suitable clause, or any combination of suitable clauses, wherein the formulation is a non-aqueous soluble liquid.
234. The method of any one of clauses 188 to 232, any other suitable clause, or any combination of suitable clauses, wherein the formulation is an aqueous soluble liquid.
235. The method of any one of clauses 188 to 232, any other suitable clause, or any combination of suitable clauses, wherein the formulation is a suspension or dispersion of the volatile compound in liquid media.
236. The method of any one of clauses 188 to 235, any other suitable clause, or any combination of suitable clauses, wherein the distance between the first location and the second location is between about 0.001 meter to about 1 meter.
237. The method of any one of clauses 188 to 236, any other suitable clause, or any combination of suitable clauses, wherein the volatile compound is a benzoxaborole.
238. The method of any one of clauses 188 to 237, any other suitable clause, or any combination of suitable clauses, wherein the volatile compound has a structure of formula (VI):

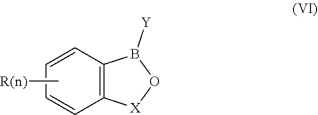

wherein each R is independently hydrogen, alkyl, alkene, alkyne, haloalkyl, haloalkene, haloalkyne, alkoxy, alkeneoxy, haloalkoxy, aryl, heteroaryl, arylalkyl, arylalkene, arylalkyne, heteroarylalkyl, heteroarylalkene, heteroarylalkyne, halogen, hydroxyl, nitrile, amine, ester, carboxylic acid, ketone, alcohol, sulfide, sulfoxide, sulfone, sulfoximine, sulfilimine, sulfonamide, sulfate, sulfonate, nitroalkyl, amide, oxime, imine, hydroxylamine, hydrazine, hydrazone, carbamate, thiocarbamate, urea, thiourea, carbonate, aryloxy, or heteroaryloxy;
n=1, 2, 3, or 4;
B is boron;
X═(CR₂)ₘ where m=1, 2, 3, or 4;
Y is alkyl, alkene, alkyne, haloalkyl, haloalkene, haloalkyne, alkoxy, alkeneoxy, haloalkoxy, aryl, heteroaryl, arylalkyl, arylalkene, arylalkyne, heteroarylalkyl, heteroarylalkene, heteroarylalkyne, hydroxyl, nitrile, amine, ester, carboxylic acid, ketone, alcohol, sulfide, sulfoxide, sulfone, sulfoximine, sulfilimine, sulfonamide, sulfate, sulfonate, nitroalkyl, amide, oxime, imine, hydroxylamine, hydrazine, hydrazone, carbamate, thiocarbamate, urea, thiourea, carbonate, aryloxy, or heteroaryloxy;
with a proviso that R is not aryloxy or heteroaryloxy when Y is hydroxyl;
and pharmaceutically or agriculturally acceptable salts thereof.
239. The method of any one of clauses 188 to 238, any other suitable clause, or any combination of suitable clauses, wherein the volatile compound has a structure of

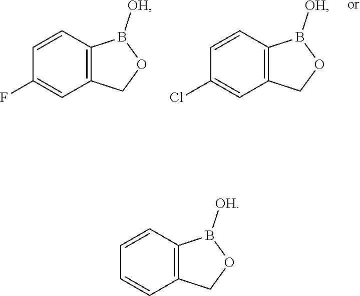 [SMILES: OB1OCc2cc(F)ccc21 ; OB1OCc2cc(Cl)ccc21 ; "or" ; OB1OCc2ccccc21]

240. The method of any one of clauses 188 to 239, any other suitable clause, or any combination of suitable clauses, wherein the volatile compound has a structure of formula (A1) or (A2):

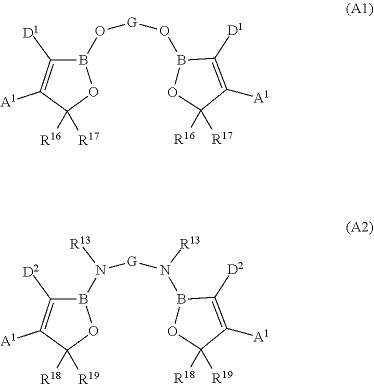

wherein each of A1, A2, D1, and D2 is independently hydrogen, substituted or unsubstituted C1-18-alkyl, arylalkyl, aryl, or heterocyclic; or A1 and D1, or A2 and D2 together form a 5, 6, or 7-membered fused ring which is substituted or unsubstituted;
each of R13, R16, R17, R18, and R19 is independently hydrogen, substituted or unsubstituted C1-6-alkyl, nitrile, nitro, aryl or aryl alkyl; or R16 and R17, or R18 and R19 together form an alicyclic ring which is substituted or unsubstituted;
B is boron;
G is a substituted or unsubstituted C1-18-alkylene, arylalkylene, arylene, or heterocyclic moiety;
and pharmaceutically or agriculturally acceptable salts thereof.
241. The method of any one of clauses 188 to 240, any other suitable clause, or any combination of suitable clauses, wherein each of R^{A} and R^{B} is independently

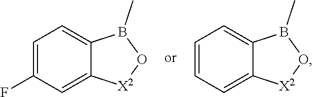

wherein X²═(CR⁶₂)ₘ and m=1, 2, 3, or 4.
242. The method of any one of clauses 188 to 241, any other suitable clause, or any combination of suitable clauses, wherein the volatile compound has a structure of

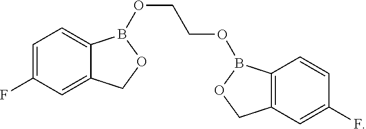 [SMILES: Fc1ccc2c(c1)COB2OCCOB1OCc2cc(F)ccc21]

243. The method of any one of clauses 188 to 242, any other suitable clause, or any combination of suitable clauses, wherein the volatile compound is present in the formulation at a concentration of about 0.001% to about 1%.
244. The method of any one of clauses 188 to 242, any other suitable clause, or any combination of suitable clauses, wherein the volatile compound is present in the formulation at a concentration of about 0.01% to about 0.1%.
245. The method of any one of clauses 188 to 242, any other suitable clause, or any combination of suitable clauses, wherein the volatile compound is present in the formulation at a concentration of about 0.02% to about 0.1%.
246. The method of any one of clauses 188 to 242, any other suitable clause, or any combination of suitable clauses, wherein the volatile compound is present in the formulation at a concentration of about 1% to about 10%.
247. The method of any one of clauses 188 to 242, any other suitable clause, or any combination of suitable clauses, wherein the volatile compound is present in the formulation at a concentration of about 10% to about 30%.
248. The method of any one of clauses 188 to 242, any other suitable clause, or any combination of suitable clauses, wherein the volatile compound is present in the formulation at a concentration of about 10% to about 60%.
249. The method of any one of clauses 188 to 242, any other suitable clause, or any combination of suitable clauses, wherein the volatile compound is present in the formulation at a concentration of about 30% to about 60%.
250. The method of any one of clauses 188 to 242, any other suitable clause, or any combination of suitable clauses, wherein the formulation comprises one or more solvents, liquid carriers, liquid media, or any combination thereof.
251. The method of clause 250, any other suitable clause, or any combination of suitable clauses, wherein the one or more solvents, liquid carriers, and liquid media is an alcohol.
252. The method of clause 250, any other suitable clause, or any combination of suitable clauses, wherein the one or more solvents, liquid carriers, and liquid media are selected from the group consisting of a glycol, a polyglycol, or combinations thereof
253. The method of clause 250, any other suitable clause, or any combination of suitable clauses, wherein the one or more solvents, liquid carriers, and liquid media are selected from the group consisting of glycerin, polyols, sugars, water, and any combination thereof.
254. The method of any one of clauses 188 to 253, any other suitable clause, or any combination of suitable clauses, wherein the formulation comprises one or more enhancing agents.
255. The method of clause 254, any other suitable clause, or any combination of suitable clauses, wherein the enhancing agents are selected from the group consisting of a spreading agent, an adhesion agent, a surfactant, a stabilizer, a surface tension reducing agent, a dynamic surface tension reducing agent, a rheology modifying agent, and any combination thereof.
256. The method of any one of clauses 188 to 255, any other suitable clause, or any combination of suitable clauses, wherein the formulation comprises one or more release modifiers.
257. The method of clause 256, any other suitable clause, or any combination of suitable clauses, wherein the release modifiers are selected from the group consisting of a thickener, a gellant, a polymer, and combinations thereof.
258. The method of any one of clauses 188 to 257, any other suitable clause, or any combination of suitable clauses, wherein the volatile compound is more uniformly distributed after the step of redistribution.
259. The method of clause 258, any other suitable clause, or any combination of suitable clauses, wherein the uniform distribution is on a surface of the target produce.
260. The method of clause 258, any other suitable clause, or any combination of suitable clauses, wherein the uniform distribution is identified via residue analysis of the volatile compound.
261. The method of any one of clauses 188 to 260, any other suitable clause, or any combination of suitable clauses, wherein the volatile component comprises a first concentration at the first location and a second concentration at the second location, wherein the second concentration is lower than the first concentration.
262. The method of any one of clauses 188 to 261, any other suitable clause, or any combination of suitable clauses, wherein the step of delivering provides the volatile component at a first mass transfer rate and the step of redistributing provides the volatile component at a second mass transfer rate, wherein the second mass transfer rate is slower than the first mass transfer rate.
263. An agricultural formulation comprising a volatile compound, any other suitable clause, or any combination of suitable clauses, wherein the volatile compound has at a vapor pressure of about 10⁻⁶ torr at 1 atm/25° C. to about 1 torr at 1 atm/25° C.
264. The agricultural formulation of clause 263, any other suitable clause, or any combination of suitable clauses, wherein the formulation further comprises one or more solvents, liquid carriers, liquid media, or any combination thereof.
265. The agricultural formulation of clause 264, any other suitable clause, or any combination of suitable clauses, wherein the one or more solvents, liquid carriers, and liquid media is an alcohol.
266. The agricultural formulation of clause 264, any other suitable clause, or any combination of suitable clauses, wherein the one or more solvents, liquid carriers, and liquid media are selected from the group consisting of a glycol, a polyglycol, or combinations thereof.
267. The agricultural formulation of clause 264, any other suitable clause, or any combination of suitable clauses, wherein the one or more solvents, liquid carriers, and liquid media are selected from the group consisting of glycerin, polyols, sugars, water, and any combination thereof.
268. The agricultural formulation of any one of clauses 263 to 267, any other suitable clause, or any combination of suitable clauses, wherein the formulation further comprises one or more enhancing agents.
269. The agricultural formulation of clause 268, any other suitable clause, or any combination of suitable clauses, wherein the enhancing agents are selected from the group consisting of a spreading agent, an adhesion agent, a surfactant, a stabilizer, a surface tension reducing agent, a dynamic surface tension reducing agent, a rheology modifying agent, and any combination thereof.
270. The agricultural formulation of any one of clauses 263 to 269, any other suitable clause, or any combination of suitable clauses, wherein the formulation further comprises one or more release modifiers.
271. The agricultural formulation of clause 270, any other suitable clause, or any combination of suitable clauses, wherein the release modifiers are selected from the group consisting of a thickener, a gellant, a polymer, and combinations thereof.
272. The agricultural formulation of any one of clauses 263 to 271, any other suitable clause, or any combination of suitable clauses, wherein the formulation comprises the volatile compound at a vapor pressure of about 10⁻⁶ torr at 1 atm/25° C. to about 1 torr at 1 atm/25° C.
273. The agricultural formulation of any one of clauses 263 to 271, any other suitable clause, or any combination of suitable clauses, wherein the formulation comprises the volatile compound at a vapor pressure of about 10⁻⁶ torr at 1 atm/25° C. to about 10⁻¹ torr at 1 atm/25° C.
274. The agricultural formulation of any one of clauses 263 to 271, any other suitable clause, or any combination of suitable clauses, wherein the formulation comprises the volatile compound at a vapor pressure of about 10⁻⁶ torr at 1 atm/25° C. to about 10⁻² torr at 1 atm/25° C.
275. The agricultural formulation of any one of clauses 263 to 271, any other suitable clause, or any combination of suitable clauses, wherein the formulation comprises the volatile compound at a vapor pressure of about 10⁻⁶ torr at 1 atm/25° C. to about 10⁻³ torr at 1 atm/25° C.
276. The agricultural formulation of any one of clauses 263 to 271, any other suitable clause, or any combination of suitable clauses, wherein the formulation comprises the volatile compound at a vapor pressure of about 10⁻⁵ torr at 1 atm/25° C. to about 10⁻³ torr at 1 atm/25° C.
277. The agricultural formulation of any one of clauses 263 to 271, any other suitable clause, or any combination of suitable clauses, wherein the formulation comprises the volatile compound at a vapor pressure of about 10⁻⁵ torr at 1 atm/25° C. to about 10⁻⁴ torr at 1 atm/25° C.
278. The agricultural formulation of any one of clauses 263 to 271, any other suitable clause, or any combination of suitable clauses, wherein the formulation comprises the volatile compound at a vapor pressure of about 10⁻⁴ torr at 1 atm/25° C. to about 10⁻³ torr at 1 atm/25° C.
279. The agricultural formulation of any one of clauses 263 to 271, any other suitable clause, or any combination of suitable clauses, wherein the formulation comprises the volatile compound at a vapor pressure of about 10⁻⁶ torr at 1 atm/25° C. to about 10⁻⁵ torr at 1 atm/25° C.
280. The agricultural formulation of any one of clauses 263 to 271, any other suitable clause, or any combination of suitable clauses, wherein the formulation comprises the volatile compound at a vapor pressure of about 10⁻³ torr at 1 atm/25° C.
281. The agricultural formulation of any one of clauses 263 to 271, any other suitable clause, or any combination of suitable clauses, wherein the formulation comprises the volatile compound at a vapor pressure of about 10⁻⁴ torr at 1 atm/25° C.
282. The agricultural formulation of any one of clauses 263 to 271, any other suitable clause, or any combination of suitable clauses, wherein the formulation comprises the volatile compound at a vapor pressure of about 10⁻⁵ torr at 1 atm/25° C.
283. The agricultural formulation of any one of clauses 263 to 271, any other suitable clause, or any combination of suitable clauses, wherein the formulation comprises the volatile compound at a vapor pressure of about 1.65×10⁻⁶ torr at 1 atm/25° C.
284. The agricultural formulation of any one of clauses 263 to 271, any other suitable clause, or any combination of suitable clauses, wherein the formulation comprises the volatile compound at a vapor pressure of about 10⁻⁶ torr at 1 atm/25° C.
285. The agricultural formulation of any one of clauses 263 to 271, any other suitable clause, or any combination of suitable clauses, wherein the formulation comprises the volatile compound at a vapor pressure of about 3.25×10⁻³ torr at 1 atm/25° C.
286. The agricultural formulation of any one of clauses 263 to 271, any other suitable clause, or any combination of suitable clauses, wherein the formulation comprises the volatile compound at a vapor pressure of about 3×10⁻³ torr at 1 atm/25° C.
287. The agricultural formulation of any one of clauses 263 to 286, any other suitable clause, or any combination of suitable clauses, wherein the volatile compound comprises a volatile antimicrobial compound against pathogens affecting meats, plants, or plant parts.
288. The agricultural formulation of any one of clauses 263 to 287, any other suitable clause, or any combination of suitable clauses, wherein the volatile compound is a benzoxaborole.
289. The agricultural formulation of any one of clauses 263 to 288, any other suitable clause, or any combination of suitable clauses, wherein the volatile compound has a structure of formula (VI):

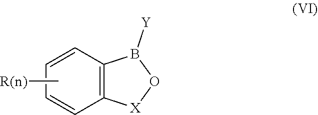

wherein each R is independently hydrogen, alkyl, alkene, alkyne, haloalkyl, haloalkene, haloalkyne, alkoxy, alkeneoxy, haloalkoxy, aryl, heteroaryl, arylalkyl, arylalkene, arylalkyne, heteroarylalkyl, heteroarylalkene, heteroarylalkyne, halogen, hydroxyl, nitrile, amine, ester, carboxylic acid, ketone, alcohol, sulfide, sulfoxide, sulfone, sulfoximine, sulfilimine, sulfonamide, sulfate, sulfonate, nitroalkyl, amide, oxime, imine, hydroxylamine, hydrazine, hydrazone, carbamate, thiocarbamate, urea, thiourea, carbonate, aryloxy, or heteroaryloxy;
n=1, 2, 3, or 4;
B is boron;
X═(CR₂)ₘ where m=1, 2, 3, or 4;
Y is alkyl, alkene, alkyne, haloalkyl, haloalkene, haloalkyne, alkoxy, alkeneoxy, haloalkoxy, aryl, heteroaryl, arylalkyl, arylalkene, arylalkyne, heteroarylalkyl, heteroarylalkene, heteroarylalkyne, hydroxyl, nitrile, amine, ester, carboxylic acid, ketone, alcohol, sulfide, sulfoxide, sulfone, sulfoximine, sulfilimine, sulfonamide, sulfate, sulfonate, nitroalkyl, amide, oxime, imine, hydroxylamine, hydrazine, hydrazone, carbamate, thiocarbamate, urea, thiourea, carbonate, aryloxy, or heteroaryloxy;
with a proviso that R is not aryloxy or heteroaryloxy when Y is hydroxyl; and pharmaceutically or agriculturally acceptable salts thereof.
290. The agricultural formulation of any one of clauses 263 to 289, any other suitable clause, or any combination of suitable clauses, wherein the volatile compound has a structure of

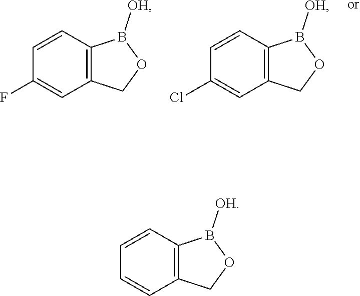 [SMILES: OB1OCc2cc(F)ccc21 ; OB1OCc2cc(Cl)ccc21 ; "or" ; OB1OCc2ccccc21]

291. The agricultural formulation of any one of clauses 263 to 290, any other suitable clause, or any combination of suitable clauses, wherein the volatile compound has a structure of formula (A1) or (A2):

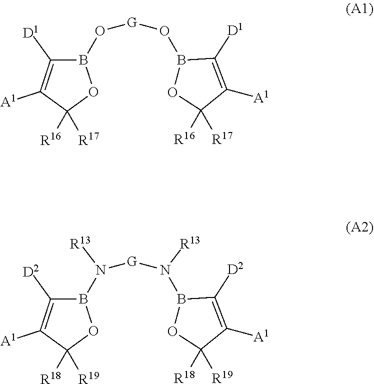

wherein each of A1, A2, D1, and D2 is independently hydrogen, substituted or unsubstituted C1-18-alkyl, arylalkyl, aryl, or heterocyclic; or A1 and D1, or A2 and D2 together form a 5, 6, or 7-membered fused ring which is substituted or unsubstituted;
each of R13, R16, R17, R18, and R19 is independently hydrogen, substituted or unsubstituted C1-6-alkyl, nitrile, nitro, aryl or aryl alkyl; or R16 and R17, or R18 and R19 together form an alicyclic ring which is substituted or unsubstituted;
B is boron;
G is a substituted or unsubstituted C1-18-alkylene, arylalkylene, arylene, or heterocyclic moiety;
and pharmaceutically or agriculturally acceptable salts thereof.
292. The agricultural formulation of any one of clauses 263 to 291, any other suitable clause, or any combination of suitable clauses, wherein each of R^{A} and R^{B} is independently

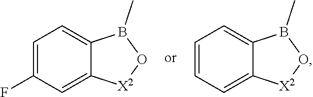

wherein X²═(CR⁶₂)ₘ and m=1, 2, 3, or 4.
293. The agricultural formulation of any one of clauses 263 to 292, any other suitable clause, or any combination of suitable clauses, wherein the volatile compound has a structure of

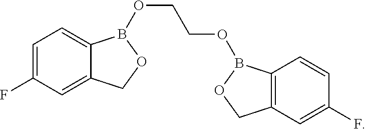 [SMILES: Fc1ccc2c(c1)COB2OCCOB1OCc2cc(F)ccc21]

294. The agricultural formulation of any one of clauses 263 to 293, any other suitable clause, or any combination of suitable clauses, wherein the volatile compound is present in the formulation at a concentration of about 0.001% to about 1%.
295. The agricultural formulation of any one of clauses 263 to 293, any other suitable clause, or any combination of suitable clauses, wherein the volatile compound is present in the formulation at a concentration of about 0.01% to about 0.1%.
296. The agricultural formulation of any one of clauses 263 to 293, any other suitable clause, or any combination of suitable clauses, wherein the volatile compound is present in the formulation at a concentration of about 0.02% to about 0.1%.
297. The agricultural formulation of any one of clauses 263 to 293, any other suitable clause, or any combination of suitable clauses, wherein the volatile compound is present in the formulation at a concentration of about 1% to about 10%.
298. The agricultural formulation of any one of clauses 263 to 293, any other suitable clause, or any combination of suitable clauses, wherein the volatile compound is present in the formulation at a concentration of about 10% to about 30%.
299. The agricultural formulation of any one of clauses 263 to 293, any other suitable clause, or any combination of suitable clauses, wherein the volatile compound is present in the formulation at a concentration of about 10% to about 60%.
300. The agricultural formulation of any one of clauses 263 to 293, any other suitable clause, or any combination of suitable clauses, wherein the volatile compound is present in the formulation at a concentration of about 30% to about 60%.

### DETAILED DESCRIPTION

Various embodiments of the invention are described herein as follows. In one embodiment described herein, a method of applying a volatile compound to a target produce is provided. The method comprises the steps of delivering a formulation comprising the volatile compound to a first location, and thereafter redistributing the volatile compound from the first location to a second location.

In another embodiment, a second method of applying a volatile compound to a target produce is provided. The method comprises the steps of delivering a formulation comprising the volatile compound to a first location, and thereafter redistributing the volatile compound from the first location to a second location, wherein the second location is on a surface of the target produce.

In yet another embodiment, a third method of applying a volatile compound to a target produce is provided. The method comprises the steps of delivering a formulation comprising the volatile compound to a first location, wherein the first location is on a first surface of the target produce and thereafter redistributing the volatile compound from the first location to a second location, wherein the second location is on a second surface of the target produce.

In another embodiment, an agricultural formulation is provided. The agricultural formulation comprises a volatile compound, wherein the volatile compound has at a vapor pressure of about 10⁻⁶ torr at 1 atm/25° C. to about 1 torr at 1 atm/25° C.

In a first aspect described herein, a method of applying a volatile compound to a target produce comprises the steps of delivering a formulation comprising the volatile compound to a first location, and thereafter redistributing the volatile compound from the first location to a second location.

In the various embodiments, the volatile compound refers to a chemical compound that is capable of being volatized. For example, the term “volatile compound” can refer to a chemical compound having a particular vapor pressure at which the chemical compound is volatile.

In some embodiments, the formulation comprises the volatile compound at a vapor pressure of about 10⁻⁶ torr at 1 atm/25° C. to about 1 torr at 1 atm/25° C. In other embodiments, the formulation comprises the volatile compound at a vapor pressure of about 10-6 torr at 1 atm/25° C. to about 10⁻¹ torr at 1 atm/25° C. In yet other embodiments, the formulation comprises the volatile compound at a vapor pressure of about 10⁻⁶ torr at 1 atm/25° C. to about 10⁻² torr at 1 atm/25° C. In some embodiments, the formulation comprises the volatile compound at a vapor pressure of about 10⁻⁶ torr at 1 atm/25° C. to about 10⁻³ torr at 1 atm/25° C. In other embodiments, the formulation comprises the volatile compound at a vapor pressure of about 10⁻⁵ torr at 1 atm/25° C. to about 10⁻³ torr at 1 atm/25° C. In yet other embodiments, the formulation comprises the volatile compound at a vapor pressure of about 10⁻⁵ torr at 1 atm/25° C. to about 10⁻⁴ torr at 1 atm/25° C. In some embodiments, the formulation comprises the volatile compound at a vapor pressure of about 10⁻⁴ torr at 1 atm/25° C. to about 10⁻³ torr at 1 atm/25° C. In other embodiments, the formulation comprises the volatile compound at a vapor pressure of about 10⁻⁶ torr at 1 atm/25° C. to about 10⁻⁵ torr at 1 atm/25° C. In yet other embodiments, the formulation comprises the volatile compound at a vapor pressure of about 10⁻³ torr at 1 atm/25° C. In some embodiments, the formulation comprises the volatile compound at a vapor pressure of about 10⁻⁴ torr at 1 atm/25° C. In other embodiments, the formulation comprises the volatile compound at a vapor pressure of about 10⁻⁵ torr at 1 atm/25° C. In yet other embodiments, the formulation comprises the volatile compound at a vapor pressure of about 1.65×10⁻⁶ torr at 1 atm/25° C. In some embodiments, the formulation comprises the volatile compound at a vapor pressure of about 10⁻⁶ torr at 1 atm/25° C. In other embodiments, wherein the formulation comprises the volatile compound at a vapor pressure of about 3.25×10⁻³ torr at 1 atm/25° C. In yet other embodiments, wherein the formulation comprises the volatile compound at a vapor pressure of about 3×10⁻³ torr at 1 atm/25° C.

In certain embodiments, the step of delivering is selected from the group consisting of spraying, misting, thermal or non-thermal fogging, drenching, dipping, submersing, and combinations thereof. In some embodiments, the step of delivering comprises spraying. In certain aspects, the spraying is selected from the group consisting of electrospraying, pneumatic air spraying, compressed air spraying, ultrasonic air spraying, air assisted ultrasonic air spraying, and combinations thereof.

In one embodiment, the spraying produces a droplet size of the formulation between about 0.01 μm to about 1 cm. In another embodiment, the spraying produces a droplet size of the formulation between about 0.01 μm to about 1000 μm. In one embodiment, the spraying produces a droplet size of the formulation between about 0.01 μm to about 100 μm. In another embodiment, the spraying produces a droplet size of the formulation between about 0.1 μm to about 1000 μm. In yet another embodiment, the spraying produces a droplet size of the formulation between about 0.1 μm to about 100 μm. In one embodiment, the spraying produces a droplet size of the formulation between about 1 μm to about 1000 μm. In another embodiment, the spraying produces a droplet size of the formulation between about 1 μm to about 100 μm. In yet another embodiment, the spraying produces a droplet size of the formulation between about 1 μm to about 10 μm.

In some embodiments, the step of delivering comprises fogging. In certain aspects, the fogging is selected from the group consisting of thermo fogging, thermal fogging, cold fogging, nebulizing, misting, air brushing, and combinations thereof.

In one embodiment, the fogging produces a droplet size of the formulation between about 0.01 μm to about 1000 μm. In another embodiment, the spraying produces a droplet size of the formulation between about 0.01 μm to about 100 μm. In yet another embodiment, the spraying produces a droplet size of the formulation between about 0.1 μm to about 1000 μm. In one embodiment, the spraying produces a droplet size of the formulation between about 0.1 μm to about 100 μm. In another embodiment, the spraying produces a droplet size of the formulation between about 1 μm to about 1000 m. In yet another embodiment, the spraying produces a droplet size of the formulation between about 1 μm to about 100 μm. In one embodiment, the spraying produces a droplet size of the formulation between about 1 μm to about 10 μm.

For instance, an exemplary formulation can comprise a volatile compound (e.g., an active ingredient) in a form of solid particulates with a typical median diameter (e.g., from about 0.1 μm to about 20 μm, from about 0.5 μm to about 15 μm, or from about 1 μm to about 10 μm). The solid particulates of active ingredient can be suspended or dispersed in liquid carriers (e.g., water) to form a consistent mixture useful for spray, drench, flood, or dip applications.

In some embodiments, the step of delivering comprises a continuous liquid application. In certain aspects, the continuous liquid application is selected from the group consisting of a drench, a dip, a submersion, a flooding, a curtain shower, and combinations thereof.

In certain embodiments, the volatile compound comprises a volatile antimicrobial compound against pathogens affecting meats, plants, or plant parts. The term “antimicrobial” is well known in the art, including concepts such as “anti-decay” and “anti-spoiling.”

In various aspects, the volatile compound is applied to a target produce wherein the target produce is a plant or a plant part. The term “plant(s)” and “plant parts” include, but not limited to, plant tissues, such as leaves, calli, stems, roots, flowers, fruits, vegetables, pollen, and seeds. A class of plants that may be used in the present invention is generally as broad as the class of higher and lower plants including, but not limited to, dicotyledonous plants, monocotyledonous plants, and plant crops, including, but not limited to, vegetable crops, fruit crops, ornamental crops, and meats.

“Vegetable crops” include, but are not limited to, asparagus, beet (e.g., sugar beet and fodder beet), beans, broccoli, cabbage, carrot, cassava, cauliflower, celery, cucumber, eggplant, garlic, gherkin, leafy greens (lettuce, kale, spinach, and other leafy greens), leek, lentils, mushroom, onion, peas, pepper (e.g., sweet peppers, bell peppers, and hot peppers), potato, pumpkin, sweet potato, snap bean, squash, tomato, and turnip.

“Fruit crops” include, but are not limited to, apple, avocado, banana, soft fruits, such as, strawberry, blueberry, raspberry, blackberry, cranberry, currents and other types of soft fruit berries, carambola, cherry, citrus (e.g., oranges, lemon, lime, mandarin, grapefruit, and other citrus), coconut, fig, grapes, guava, kiwifruit, mango, nectarine, melons (including cantaloupe, muskmelon, watermelon, and other melons), olive, papaya, passionfruit, peach, pear, persimmon, pineapple, plum, and pomegranate. More specifically, horticultural crops of the present disclosure include, but are not limited to, soft fruits (e.g., grape, apple, pear, and persimmon) and berries (e.g., strawberries, blackberries, blueberries, and raspberries).

“Ornamental crops” include, but are not limited to, baby's breath, carnation, dahlia, daffodil, geranium, gerbera, lily, orchid, peony, Queen Anne's lace, rose, snapdragon, or other cut-flowers or ornamental flowers, potted flowers, flower bulbs, shrub, and deciduous or coniferous tree.

“Meat” or “Meats” include, but are not limited to beef, bison, chicken, deer, goat, turkey, pork, sheep, fish, shellfish, mollusks, or dry-cured meat products.

The methods provided by the present disclosure are premised on delivering a formulation comprising the volatile compound to a first location, and thereafter redistributing the volatile compound from the first location to a second location. As described herein, the “first location” and the “second location” can be specified to be as various sites.

In various embodiments, the first location is a post-harvest processing facility. In some embodiments, the post-harvest processing facility is a storage room. In other embodiments, the post-harvest processing facility is a packing house. In yet other embodiments, the post-harvest processing facility is a packing or sorting line. In some embodiments, the post-harvest processing facility is a transit center. In other embodiments, the post-harvest processing facility is a distribution center. In yet other embodiments, the post-harvest processing facility is a field packing area.

For instance, a storage room can be a long term cold storage room. The storage room can be present with or without a controlled atmosphere, with or without ventilation, and with or without air scrubbing/cleaning mechanisms.

For instance, a post-harvest processing facility can be a space or an enclosure such as holding room, cooling room, degreening room, and the like.

For instance, a post-harvest processing facility can be a transport enclosure such as a container, a pallet wrap, a pallet cover, and the like.

For instance, a produce packaging enclosure can be utilized according to the present disclosure. The produce packaging enclosure can be, for example, a box, a liner bag, a retail bag, a clamshell, a punnet, a perforated managed atmosphere package (MAP), a microperforated MAP, a perforated modified atmosphere package, a microperforated modified atmosphere package, and the like.

In some embodiments, the first location is a composition located near the target produce. In various aspects, the composition located near the target produce is within about 1 meter of the target produce.

In various embodiments, the first location is selected from the group consisting of a storage room, a package, a container, a pallet, a bin, a bag, a case, a clamshell, and a composition located near the target produce.

In one embodiment, the first location is a storage room. In another embodiment, the first location is a package. In yet another embodiment, the first location is a bin. In one embodiment, the first location is a bag. In another embodiment, the first location is a case. In yet another embodiment, the first location is a clamshell.

In some embodiments, the second location is an enclosed space or a partially enclosed space. In various embodiments, the second location is selected from the group consisting of a storage room, a package, a container, a pallet, a bin, a bag, a case, a clamshell, and a composition located near the target produce.

In one embodiment, the second location is a storage room. In another embodiment, the second location is a package. In yet another embodiment, the second location is a bin. In one embodiment, the second location is a bag. In another embodiment, the second location is a case. In yet another embodiment, the second location is a clamshell.

In some embodiments, the second location is a composition located near the target produce. In various aspects, the composition located near the target produce is within about 1 meter of the target produce.

In various aspects, wherein the step of delivering provides the volatile compound to a first percentage of available surface area coverage and the step of redistributing provides the volatile compound to a second percentage of available surface area coverage that is greater than the first percentage of available surface area coverage.

In some embodiments, the partially enclosed space is between about 50% to 100% enclosed from an outside environment. In some embodiments, the partially enclosed space is between about 60% to 100% enclosed from an outside environment. In other embodiments, the partially enclosed space is between about 70% to 100% enclosed from an outside environment. In yet other embodiments, the partially enclosed space is between about 70% to 90% enclosed from an outside environment.

In certain aspects, the formulation is a non-aqueous soluble liquid. In other aspects, the formulation is an aqueous soluble liquid. In yet other aspects, the formulation is a suspension or dispersion of the volatile compound in liquid media.

In some embodiments, the distance between the first location and the second location is between about 0.001 meter to about 1 meter. In other embodiments, the distance between the first location and the second location is between about 0.01 meter to about 1 meter.

In yet other embodiments, the distance between the first location and the second location is between about 0.1 meter to about 1 meter.

In certain aspects, the volatile compound is a benzoxaborole. In some embodiments, the volatile compound of the invention has a structure of formula (I), (II), or (III):

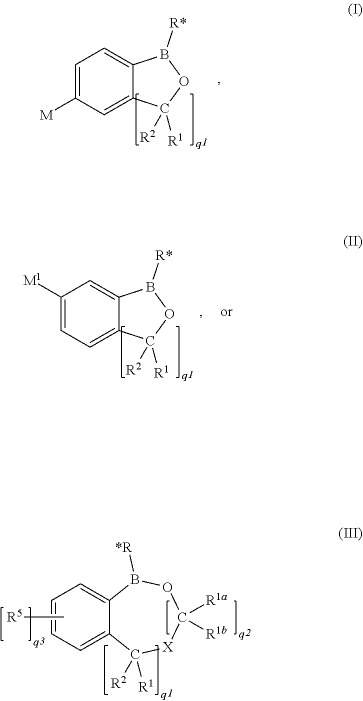

wherein q1 and q2 are independently 1, 2, or 3;

q3=0, 1, 2, 3, or 4;

M is hydrogen, halogen, —OCH₃, or —CH₂—O—CH₂—O—CH₃;

M¹ is halogen, —CH₂OH, or —OCH₃;

X is O, S, or NR^{1c}, wherein R^{1c} is hydrogen, substituted alkyl, or unsubstituted alkyl;

R¹, R^{1a}, R^{1b}, R², and R⁵ are independently hydrogen, OH, NH₂, SH, CN, NO₂, SO₂, OSO₂OH, OSO₂NH₂, substituted or unsubstituted cycloalkyl, substituted or unsubstituted heterocycloalkyl, substituted or unsubstituted aryl, or substituted or unsubstituted heteroaryl; R* is substituted or unsubstituted aryl, substituted or unsubstituted arylalkyl, substituted or unsubstituted heteroaryl, substituted or unsubstituted heteroarylalkyl, or substituted or unsubstituted vinyl;

with a proviso that when M is F, R* is not a member selected from:

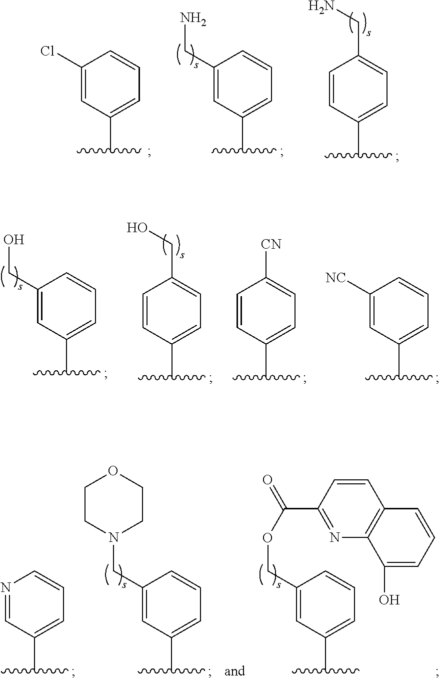

and with a proviso that when M is Cl, R* is not a member selected from:

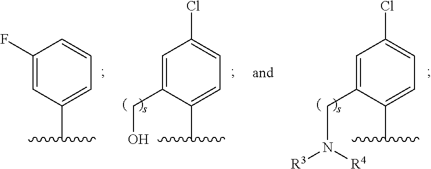

and with a proviso that when M is hydrogen, R* is not a member selected from:

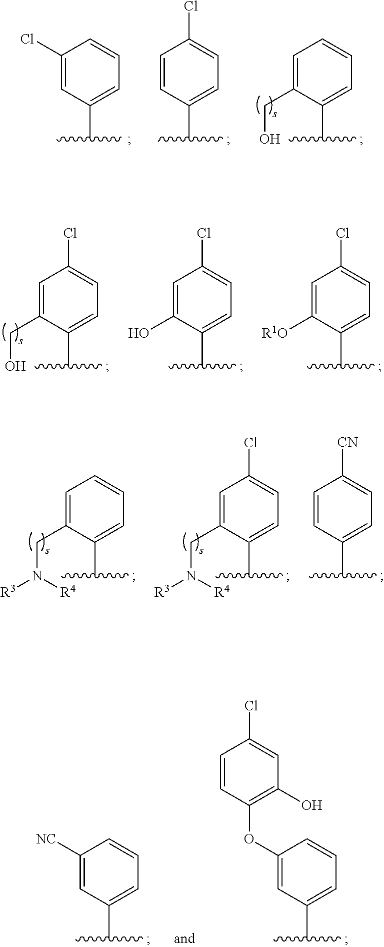

wherein s=1 or 2; and R³ and R⁴ are independently methyl or ethyl;

and with a provision that when M is OCH₃, R* is not a member selected from:

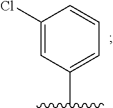 [SMILES: *c1cccc(Cl)c1 ; ";"]

and with a provision that when M¹ is F, R* is not a member selected from:

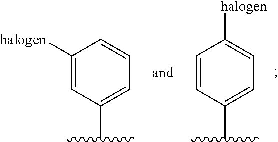

and pharmaceutically acceptable salts thereof.

In one embodiment, the R* has a structure selected from:

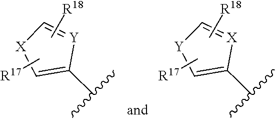

wherein X is a member selected from CH═CH, N═CH, NR¹⁴, O and S;

wherein R¹⁴ is a member selected from H, substituted or unsubstituted alkyl, substituted or unsubstituted aryl and substituted or unsubstituted arylalkyl;

Y is a member selected from CH and N;

R¹⁷ and R¹⁸ are members independently selected from H, substituted or unsubstituted alkyl, substituted or unsubstituted aryl, substituted or unsubstituted arylalkyl, (CH₂)ᵥOH, (CH₂)_{w}NR¹⁵R¹⁶, CO₂H, C₂-alkyl, CONH₂, S-alkyl, S-aryl, SO-alkyl, SO-aryl, SO₂-alkyl, SO₂-aryl, SO₂H, SCF₂, CN, halogen, CF₃ and NO₂;

wherein R¹⁵ and R¹⁶ are members independently selected from hydrogen, substituted or unsubstituted alkyl and substituted or unsubstituted alkanoyl;

v=1, 2, or 3; and

w=0, 1, 2, or 3.

In another embodiment, the R* has the following structure:

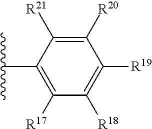

wherein R¹⁷, R¹⁸, R¹⁹, R²⁰, and R²¹ are independently selected from H, substituted or unsubstituted alkyl, substituted or unsubstituted aryl, substituted or unsubstituted arylalkyl, substituted or unsubstituted alkyloxy, substituted or unsubstituted aryloxy, substituted or unsubstituted oxazolidin-2-yl, (CH₂)ₜOH, CO₂H, CO₂-alkyl, CONH₂, CONH-alkyl, CON(alkyl)₂, OH, SH, S-alkyl, S-aryl, SO-alkyl, SO-aryl, SO₂-alkyl, SO₂-aryl, SO₂H, SCF₃, CN, halogen, CF₃, NO₂, (CH₂)ᵤNR²²R²³, SO₂NH₂, OCH₂CH₂NH₂, OCH₂CH₂NH-alkyl and OCH₂CH₂N(alkyl)₂;

wherein t=1, 2 or 3;

u=0, 1, or 2;

R²² and R²³ are independently selected from H, substituted or unsubstituted alkyl, and substituted or unsubstituted alkanoyl.

In another embodiment, the R* has the following structure:

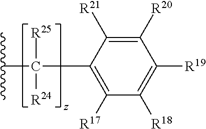

wherein R¹⁷, R¹⁸, R¹⁹, R²⁰, and R²¹ are independently selected from H, substituted or unsubstituted alkyl, substituted or unsubstituted aryl, substituted or unsubstituted arylalkyl, substituted or unsubstituted alkyloxy, substituted or unsubstituted aryloxy, substituted or unsubstituted oxazolidin-2-yl, (CH₂)ₜOH, CO₂H, CO₂-alkyl, CONH₂, CONH-alkyl, CON(alkyl)₂, OH, SH, S-alkyl, S-aryl, SO-alkyl, SO-aryl, SO₂-alkyl, SO₂-aryl, SO₂H, SCF₃, CN, halogen, CF₃, NO₂, (CH₂)ᵤNR²²R²³, SO₂NH₂, OCH₂CH₂NH₂, OCH₂CH₂NH-alkyl and OCH₂CH₂N(alkyl)₂;

wherein t=1, 2 or 3;

u=0, 1, or 2;

R²² and R²³ are independently selected from H, substituted or unsubstituted alkyl, and substituted or unsubstituted alkanoyl;

R²⁴ and R²⁵ are independently selected from H, substituted or unsubstituted alkyl, substituted or unsubstituted aryl, substituted or unsubstituted arylalkyl, substituted or unsubstituted alkyloxy, substituted or unsubstituted aryloxy, substituted or unsubstituted oxazolidin-2-yl, (CH₂), OH, CO₂H, CO₂-alkyl, CONH₂, CONH-alkyl, CON(alkyl)₂, OH, SH, S-alkyl, S-aryl, SO-alkyl, SO-aryl, SO₂-alkyl, SO₂-aryl, SO₃H, SCF₃, CN, halogen, CF₃, NO₂, (CH₂)ᵤNR²²R²³, SO₂NH₂, OCH₂CH₂NH₂, OCH₂CH₂NH-alkyl and OCH₂CH₂N(alkyl)₂;

Z=1, 2, 3, 4, 5, or 6.

Additional volatile compounds are also disclosed previously in U.S. Pat. No. 8,106,031, and International Patent Application WO 2007/131072A2, the contents of which are hereby incorporated by reference in their entireties.

In some embodiments, the volatile compound of the invention has the structure of formula (IV):

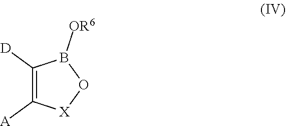

wherein A and D together with the carbon atoms to which they are attached form a 5-6- or 7-membered fused ring which may be substituted by C₁-C₆-alkyl, C₁-C₆-alkoxy, hydroxy, halogen, nitro, nitrile, amino, amino substituted by one or more C₁-C₆-alkyl groups, carboxy, acyl, aryloxy, carbonamido, carbonamido substituted by C₁-C₆-alkyl, sulfonamido or trifluoromethyl or the fused ring may link two oxaborole rings;

X is a group —CR⁷R⁸ wherein R⁷ and R⁸ are each independently hydrogen, C₁-C₆-alkyl, nitrile. nitro, aryl, arylalkyl or R⁷ and R⁸ together with the carbon atom to which they are attached form an alicyclic ring; and

R⁶ is hydrogen, C₁-C₁₈-alkyl, C₁-C₁₈-alkyl substituted by C₁-C₆-alkoxy, C₁-C₆ alkylthio, hydroxy, amino, amino substituted by C₁-C₁₈-alkyl, carboxy, aryl, aryloxy, carbonamido, carbonamido substituted by C₁-C₆-alkyl, aryl or arylalkyl, arylalkyl, aryl, heteroaryl, cycloalkyl, C₁-C₁₈-alkyleneamino, C₁-C₁₈-alkyleneamino substituted by phenyl, C₁-C₆-alkoxy or C₁-C₆-alkylthio, carbonyl alkyleneamino or a radical of formula (V):

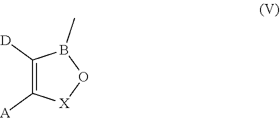

wherein A, D and X are as defined herein before except for boronophthalide;

and pharmaceutically acceptable salts thereof.

In one embodiment, the volatile compound of the invention has the structure of formula (IX):

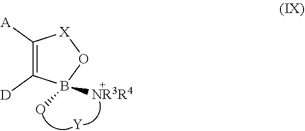

wherein A, D, and X are defined as above;

Y is a divalent alkylene linking group containing up to 18 carbon atoms or a divalent alkylene linking group containing up to 18 carbon atoms which is substituted by phenyl, C₁-C₆ alkoxy, C₁-C₆-alkylthio; carbonyl alkylene amino; and

R³ and R⁴ are each, independently, hydrogen, C₁-C₁₈-alkyl or phenyl or R³ together with Y or part of Y forms a 5-, 6- or 7-membered ring containing the nitrogen atom.

In another embodiment, the volatile compound of the invention has the structure of formula (X):

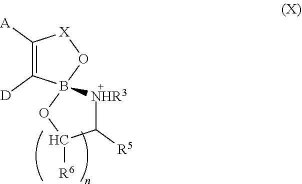

wherein A, D, and X are defined as above;

n is 1, 2, or 3;

R³ is hydrogen, C₁-C₁₈-alkyl or phenyl; and

R⁵ and R⁶ are each, independently, hydrogen, alkyl containing up to a total of 16 carbon atoms or phenyl.

Additional volatile compounds are also disclosed previously in U.S. Pat. No. 5,880,188, the content of which is hereby incorporated by reference in its entirety.

In another aspect, the volatile compound of the invention has the structure of formula (VI):

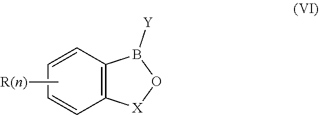

wherein each R is independently hydrogen, alkyl, alkene, alkyne, haloalkyl, haloalkene, haloalkyne, alkoxy, alkeneoxy, haloalkoxy, aryl, heteroaryl, arylalkyl, arylalkene, arylalkyne, heteroarylalkyl, heteroarylalkene, heteroarylalkyne, halogen, hydroxyl, nitrile, amine, ester, carboxylic acid, ketone, alcohol, sulfide, sulfoxide, sulfone, sulfoximine, sulfilimine, sulfonamide, sulfate, sulfonate, nitroalkyl, amide, oxime, imine, hydroxylamine, hydrazine, hydrazone, carbamate, thiocarbamate, urea, thiourea, carbonate, aryloxy, or heteroaryloxy;

n=1, 2, 3, or 4;

B is boron;

X═(CR₂)ₘ where m=1, 2, 3, or 4;

Y is alkyl, alkene, alkyne, haloalkyl, haloalkene, haloalkyne, alkoxy, alkeneoxy, haloalkoxy, aryl, heteroaryl, arylalkyl, arylalkene, arylalkyne, heteroarylalkyl, heteroarylalkene, heteroarylalkyne, hydroxyl, nitrile, amine, ester, carboxylic acid, ketone, alcohol, sulfide, sulfoxide, sulfone, sulfoximine, sulfilimine, sulfonamide, sulfate, sulfonate, nitroalkyl, amide, oxime, imine, hydroxylamine, hydrazine, hydrazone, carbamate, thiocarbamate, urea, thiourea, carbonate, aryloxy, or heteroaryloxy;

with a proviso that R is not aryloxy or heteroaryloxy when Y is hydroxyl;

and pharmaceutically acceptable salts thereof.

In one embodiment, the volatile compound has a structure of formula (VII):

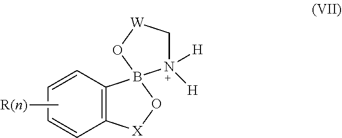

wherein W═(CH₂)_{q} where q is 1, 2, or 3.

In another embodiment, the volatile compound has a structure of

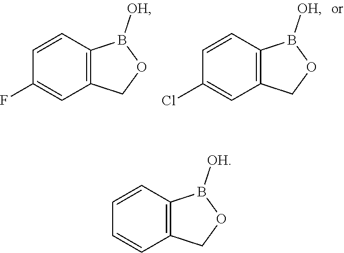

In another embodiment, the volatile compound of the invention has the structure of formula (VIII):

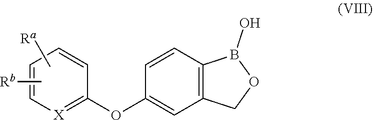

wherein R^{a} is CN, C(O)NR⁹R¹⁰, or C(O)OR¹¹ wherein R¹¹ is hydrogen, substituted alkyl, or unsubstituted alkyl,

X is N, CH and CR^{b};

R^{b} is halogen, substituted or unsubstituted alkyl, C(O)R², C(O)OR¹², OR¹², NR¹²R¹³, wherein R⁹, R¹⁰, R¹², and R¹³ are independently hydrogen, substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl;

with a proviso that R⁹ and R¹⁰, together with the atoms to which they are attached, are optionally combined to form a 4- to 8-membered substituted or unsubstituted heterocycloalkyl ring;

and with a proviso that R¹² and R¹³, together with the atoms to which they are attached, are optionally combined to form a 4- to 8-membered substituted or unsubstituted heterocycloalkyl ring;

and pharmaceutically acceptable salts thereof.

In one embodiment, the volatile compound of the invention has the structure of formula (XI):

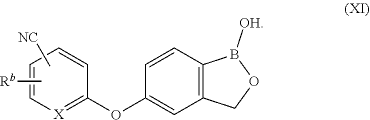

In another embodiment, the volatile compound of the invention is selected from:

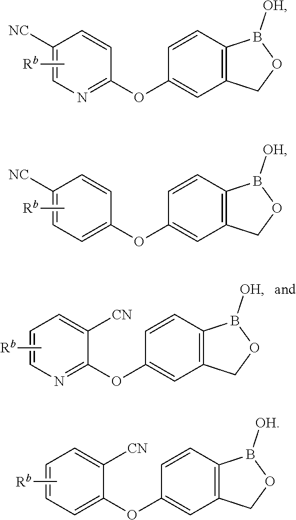

In another embodiment, the volatile compound of the invention is selected from:

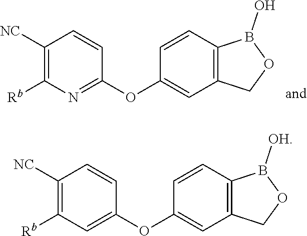

In another embodiment, the volatile compound of the invention is selected from:

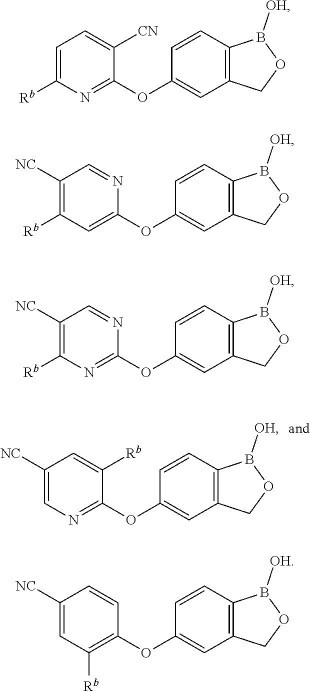

In one embodiment, the volatile compound of the invention has the structure of formula (XII):

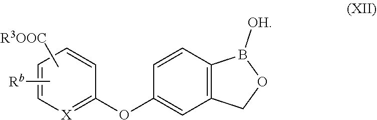

In another embodiment, the volatile compound of the invention is selected from:

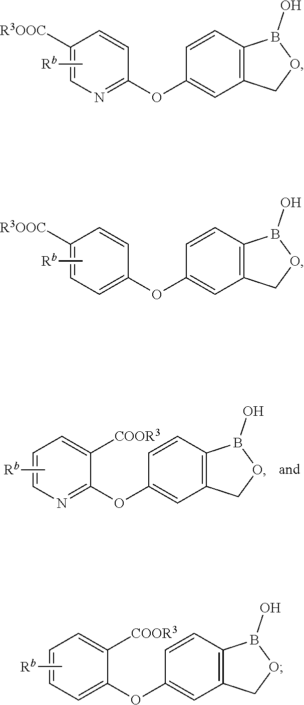

wherein R³ is hydrogen, substituted or unsubstituted alkyl, or substituted or unsubstituted heteroalkyl.

In another embodiment, the volatile compound of the invention is selected from:

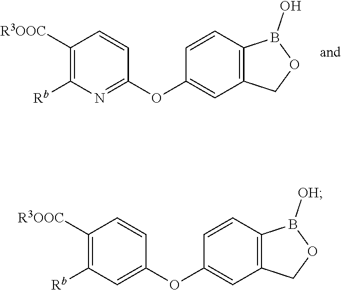

wherein R³ is hydrogen, substituted or unsubstituted alkyl, or substituted or unsubstituted heteroalkyl.

In another embodiment, the volatile compound of the invention is selected from:

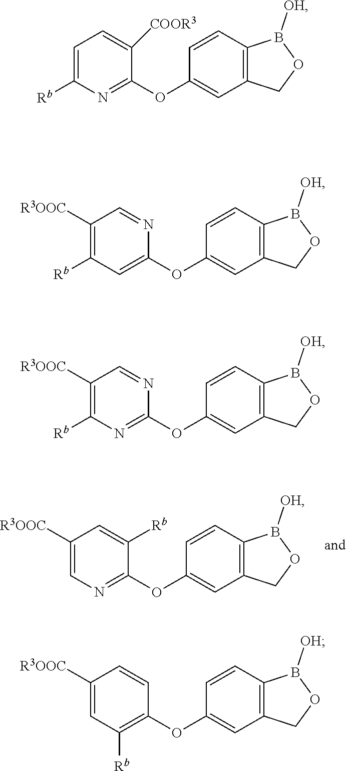

wherein R³ is hydrogen, substituted or unsubstituted alkyl, or substituted or unsubstituted heteroalkyl.

In one embodiment, the volatile compound of the invention has the structure of formula (XIII):

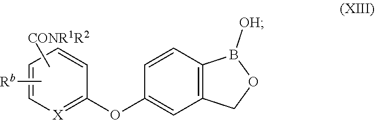

wherein each of R¹ and R² is independently hydrogen, substituted or unsubstituted alkyl, or substituted or unsubstituted heteroalkyl.

In another embodiment, the volatile compound of the invention is selected from:

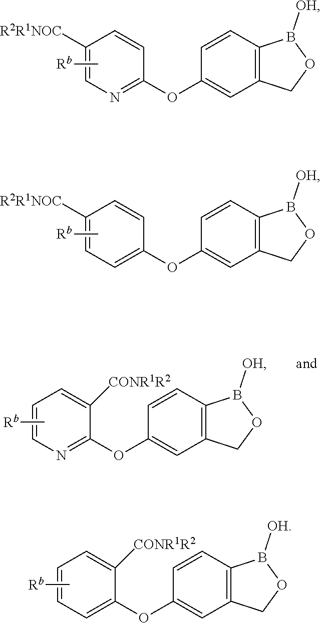

In another embodiment, the volatile compound of the invention is selected from:

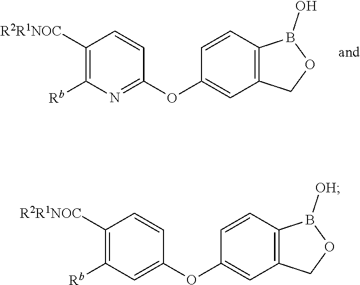

wherein each of R¹ and R² is independently hydrogen, substituted or unsubstituted alkyl, or substituted or unsubstituted heteroalkyl.

In another embodiment, the volatile compound of the invention is selected from:

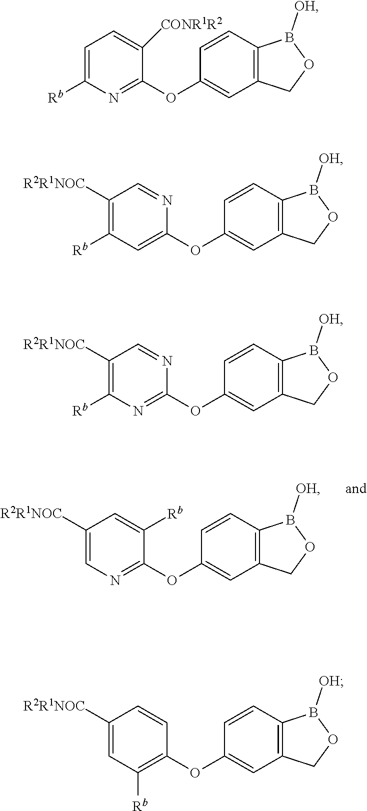

wherein each of R¹ and R² is independently hydrogen, substituted or unsubstituted alkyl, or substituted or unsubstituted heteroalkyl.

In one embodiment, R^{b} is selected from fluorine and chlorine. In another embodiment, R^{b} is selected from OR²⁶ and NR²⁷R²⁸. In another embodiment when R^{b} is OR²⁶, R²⁶ is selected from H, substituted or unsubstituted alkyl, substituted or unsubstituted heteroalkyl, substituted or unsubstituted cycloalkyl, substituted or unsubstituted heterocycloalkyl, substituted or unsubstituted aryl, and substituted or unsubstituted heteroaryl. In another embodiment when R^{b} is OR²⁶, R²⁶ is selected from H, substituted or unsubstituted alkyl, substituted or unsubstituted heteroalkyl and substituted or unsubstituted cycloalkyl. In another embodiment when R^{b} is OR²⁶, R²⁶ is unsubstituted C₁-C₆ alkyl. In another embodiment when R^{b} is OR²⁶, R²⁶ is unsubstituted cycloalkyl. In another embodiment when R^{b} is OR²⁶, R²⁶ is alkyl, substituted with a member selected from substituted or unsubstituted C₁-C₆ alkoxy. In another embodiment when R^{b} is OR²⁶, R²⁶ is alkyl, substituted with at least one halogen. In another embodiment when R^{b} is OR²⁶, R²⁶ is alkyl, substituted with at least one oxo moiety.

In another embodiment when R^{b} is OR²⁶, R²⁶ is a member selected from —CH₃, —CH₂CH₃, —(CH₂)₂CH₃, —CH(CH₃)₂, —CH₂CF₃, —CH₂CHF₂, —CH₂CH₂(OH), —CH₂CH₂(OCH₃), —CH₂CH₂(OC(CH₃)₂), —C(O)CH₃, —CH₂CH₂OC(O)CH₃, —CH₂C(O)OCH₂CH₃, —CH₂C(O)OC(CH₃)₃, —(CH₂)₃C(O)CH₃, —CH₂C(O)OC(CH₃)₃, cyclopentyl, cyclohexyl,

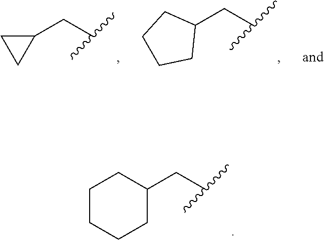 [SMILES: *CC1CC1 ; *CC1CCCC1 ; *CC1CCCCC1]

In another embodiment when R^{b} is NR²⁷R²⁸, R²⁷ and R²⁸ are members independently selected from H, substituted or unsubstituted alkyl, substituted or unsubstituted heteroalkyl, substituted or unsubstituted cycloalkyl, substituted or unsubstituted heterocycloalkyl, substituted or unsubstituted aryl, and substituted or unsubstituted heteroaryl. In another embodiment when R^{b} is NR²⁷R²⁸, R²⁷ is H or unsubstituted alkyl; and R²⁸ is unsubstituted alkyl or alkyl substituted with a member selected from hydroxyl, phenyl, unsubstituted alkoxy and alkoxy substituted with a phenyl. In a further embodiment when R^{b} is NR²⁷R²⁸, R²⁷ is H or CH₃.

In another embodiment when R^{b} is NR²⁷R²⁸, R²⁷ and R²⁸ are independently selected from substituted or unsubstituted alkyl. In another embodiment when R^{b} is NR²⁷R²⁸, R²⁷ is unsubstituted alkyl; and R²⁸ is substituted or unsubstituted alkyl. In another embodiment when R^{b} is NR²⁷R²⁸, R²⁷ is unsubstituted alkyl; and R²⁸ is alkyl, substituted with a member selected from substituted or unsubstituted alkoxy and hydroxyl. In another embodiment when R^{b} is NR²⁷R²⁸, R²⁷ is unsubstituted alkyl; and R²⁸ is alkyl, substituted with unsubstituted alkoxy. In another embodiment when R^{b} is NR²⁷R²⁸, R²⁷ is unsubstituted alkyl; and R²⁸ is alkyl, substituted with alkoxy, substituted with phenyl. In another embodiment when R^{b} is NR²⁷R²⁸, R²⁷ is unsubstituted alkyl; and R²⁸ is alkyl, substituted with unsubstituted alkoxy. In another embodiment when R^{b} is NR²⁷R²⁸, R²⁷ and R²⁸ together with the nitrogen to which they are attached, are combined to form a 4- to 8-membered substituted or unsubstituted heterocycloalkyl ring. In another embodiment when R is NR²⁷R²⁸, R²⁷ and R²⁸ together with the nitrogen to which they are attached, are combined to form a 5- or 6-membered substituted or unsubstituted heterocycloalkyl ring.

In another embodiment, R^{b} is selected from N(CH₃)₂, N(CH₃)(CH₂CH₂(OCH₃)), N(CH₃)(CH₂CH₂OH), NH₂, NHCH₃, NH(CH₂CH₂(OCH₃)), NH(CH₂CH₂(OCH₂Ph), NH(CH₂Ph), NH(C(CH₃)₃) and NH(CH₂CH₂OH). In another embodiment, R^{b} is selected from

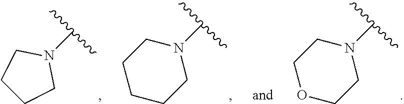 [SMILES: *N1CCCC1 ; *N1CCCCC1 ; *N1CCOCC1]

Additional volatile compounds are also disclosed previously in U.S. Pat. No. 8,039,450, and patent application publication US 2009/0291917, the contents of which are hereby incorporated by reference in their entireties.

In one aspect, the volatile compound of the invention has the structure of formula (A):

R^{A}-L^{A}-G-L^{B}-R^{B} (A),

wherein

each of R^{A} and R^{B} is independently a radical comprising an oxaborole moiety;

each of L^{A} and L^{B} is independently —O— or

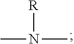

each of R and R′ is independently hydrogen, unsubstituted or substituted C₁₋₁₈-alkyl, arylalkyl, aryl, or heterocyclic moiety; and

G is a substituted or unsubstituted C₁₋₁₈-alkylene, arylalkylene, arylene, or heterocyclic moiety; and pharmaceutically acceptable salts thereof.

In one embodiment, the volatile compound has use against pathogens affecting meats, plants, or plant parts, comprising contacting the meats, plants, or plant parts. In another embodiment, the -L^{A}-G-L^{B}- portion of formula (A) is derived from a diol or diamine compound. In a further embodiment, the diol compound is selected from the group consisting of 1,2-ethylene glycol; 1,2-propylene glycol; 1,3-propylene glycol; 1,1,2,2-tetramethyl-1,2-ethylene glycol; 2,2-dimethyl-1,3-propylene glycol; 1,6-hexanediol; 1,10-decanediol; and combinations thereof. In another embodiment, the diamine compound is 1,2-ethylene diamine; 1,3-propylene diamine; or combinations thereof. In another embodiment, L^{A} and L^{B} are identical. In another embodiment, L^{A} and L^{B} are different. In another embodiment, each of L^{A} and L^{B} is independently —O— or —NH—. In another embodiment, L^{A} and L^{B} are identical. In another embodiment, L^{A} and L^{B} are different.

In another embodiment, the -L^{A}-G-L^{B}- portion of formula (A) comprises asymmetrical functional groups (i.e., asymmetrical bridges). In a further embodiment, the -L^{A}-G-L^{B}- portion of formula (A) comprises one hydroxyl group and one amine group. In a further embodiment, the -L^{A}-G-L^{B}- portion of formula (A) comprises an amino alcohol. In another embodiment, G is a substituted or unsubstituted C₁_8-alkylene. In a further embodiment, G is a substituted or unsubstituted C₁₋₄-alkylene. In a further embodiment, G is selected from —CH₂—, —CH₂—CH₂—, and —CH₂—CH₂—CH₂—.

In another embodiment, each of R^{A} and R^{B} is independently derived from the group consisting of 5-fluoro-1,3-dihydro-1-hydroxy-2,1-benzoxaborole; 5-chloro-1,3-dihydro-1-hydroxy-2,1-benzoxaborole; 1,3-dihydro-1-hydroxy-2,1-benzoxaborole; and combinations thereof. In another embodiment, R^{A} and R^{B} are identical. In another embodiment, R^{A} and R^{B} are different.

In another embodiment, at least one of R^{A} and R^{B} is selected from formula (B), (C), or (D):

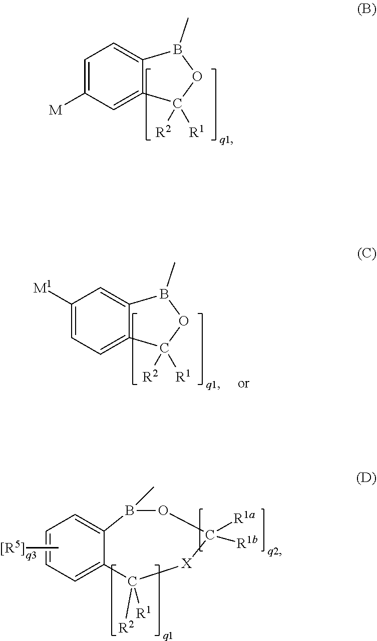

wherein q1 and q2 are independently 1, 2, or 3;

q3=0, 1, 2, 3, or 4;

B is boron;

M is hydrogen, halogen, —OCH₃, or —CH₂—O—CH₂—O—CH₃;

M¹ is halogen, —CH₂OH, or —OCH₃;

X is O, S, or NR^{1c}, wherein R^{1c} is hydrogen, substituted alkyl, or unsubstituted alkyl; R¹, R^{1a}, R^{1b}, R², and R⁵ are independently hydrogen, OH, NH₂, SH, CN, NO₂, SO₂, OSO₂OH, OSO₂NH₂, substituted or unsubstituted cycloalkyl, substituted or unsubstituted heterocycloalkyl, substituted or unsubstituted aryl, or substituted or unsubstituted heteroaryl;

and pharmaceutically acceptable salts thereof.

Additional oxaborole moieties are also disclosed previously in U.S. Pat. No. 8,106,031, and International Patent Application WO 2007/131072A2, the contents of which are hereby incorporated by reference in their entireties.

In another embodiment, at least one of R^{A} and R^{B} has a structure of formula (F):

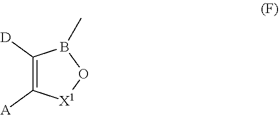

wherein A and D together with the carbon atoms to which they are attached form a 5, 6, or 7-membered fused ring which may be substituted by C₁₋₆-alkyl, C₁₋₆-alkoxy, hydroxy, halogen, nitro, nitrile, amino, amino substituted by one or more C₁₋₆-alkyl groups, carboxy, acyl, aryloxy, carbonamido, carbonamido substituted by C₁₋₆-alkyl, sulphonamido or trifluoromethyl or the fused ring may link two oxaborole rings; B is boron;

X¹ is a group —CR⁷R⁸ wherein R⁷ and R⁸ are each independently hydrogen, C₁₋₆-alkyl, nitrile, nitro, aryl, aralkyl or R⁷ and R⁸ together with the carbon atom to which they are attached form an alicyclic ring; and

and pharmaceutically acceptable salts thereof.

Additional oxaborole moieties are also disclosed previously in U.S. Pat. No. 5,880,188, the content of which is hereby incorporated by reference in its entirety.

In another embodiment, at least one of R^{A} and R^{B} is selected from formula (E) or (G):

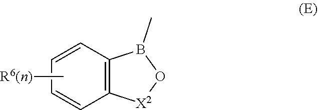

wherein each R⁶ is independently hydrogen, alkyl, alkene, alkyne, haloalkyl, haloalkene, haloalkyne, alkoxy, alkeneoxy, haloalkoxy, aryl, heteroaryl, arylalkyl, arylalkene, arylalkyne, heteroarylalkyl, heteroarylalkene, heteroarylalkyne, halogen, hydroxyl, nitrile, amine, ester, carboxylic acid, ketone, alcohol, sulfide, sulfoxide, sulfone, sulfoximine, sulfilimine, sulfonamide, sulfate, sulfonate, nitroalkyl, amide, oxime, imine, hydroxylamine, hydrazine, hydrazone, carbamate, thiocarbamate, urea, thiourea, carbonate, aryloxy, or heteroaryloxy;

n=1, 2, 3, or 4;

B is boron;

X²═(CR⁶₂)ₘ where m=1, 2, 3, or 4; or

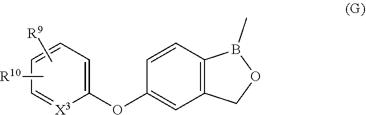

wherein R⁹ is CN, C(O)NR¹¹R¹², or C(O)OR³ wherein R³ is hydrogen, substituted alkyl, or unsubstituted alkyl,

X³ is N, CH and CR¹⁰;

R¹⁰ is halogen, substituted or unsubstituted alkyl, C(O)R¹⁴, C(O)OR¹⁴, OR¹⁴, NR¹⁴R¹⁵, wherein each of R¹¹, R¹², R¹⁴, and R¹⁵ is independently hydrogen, substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl;

and pharmaceutically acceptable salts thereof.

In a further embodiment when at least one of R^{A} and R^{B} has a structure of formula (G), R⁹ is CN and R¹⁰ is R^{b}.

In another embodiment, at least one of R^{A} and R^{B} has a structure selected from:

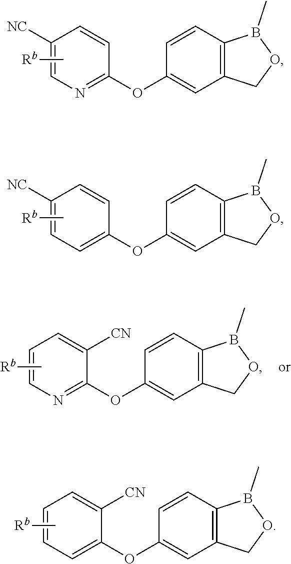

In another embodiment, at least one of R^{A} and R^{B} has a structure selected from:

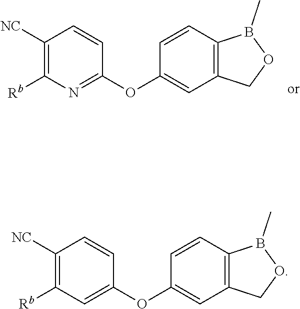

In another embodiment, at least one of R^{A} and R^{B} has a structure selected from:

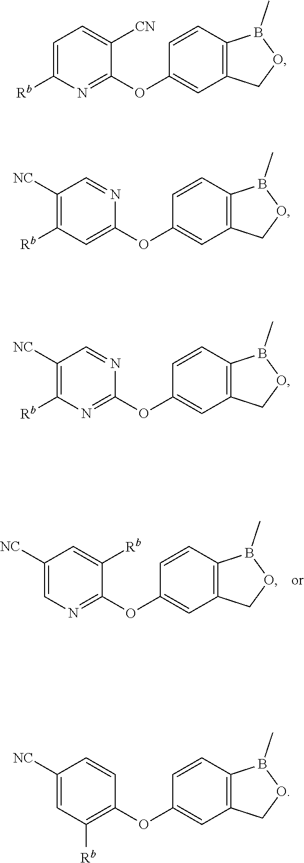

In another embodiment when at least one of R^{A} and R^{B} has a structure of formula (G), R⁹ is —COOR³ and R¹⁰ is R^{b}.

In another embodiment, at least one of R^{A} and R^{B} has a structure selected from:

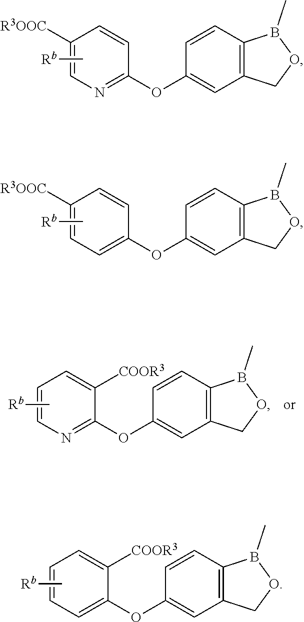

In another embodiment, at least one of R^{A} and R^{B} has a structure selected from:

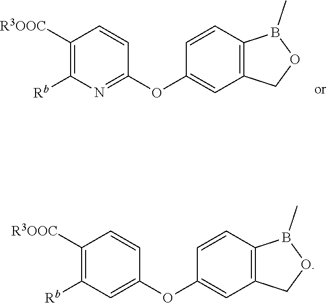

In another embodiment, at least one of R^{A} and R^{B} has a structure selected from:

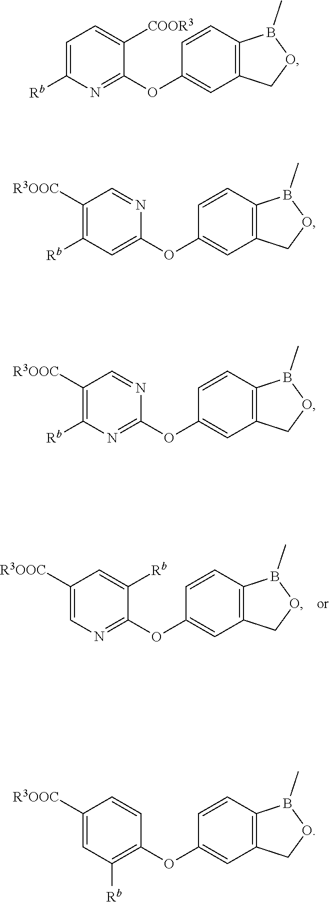

In another embodiment when at least one of R^{A} and R^{B} has a structure of formula (G), R⁹ is —CONR¹R² and R¹⁰ is R^{b}.

In another embodiment, each of R^{A} and R^{B} is independently selected from formula (B), (C), (D), (E), (F), or (G).

In another embodiment, the volatile compound of the invention is selected from:

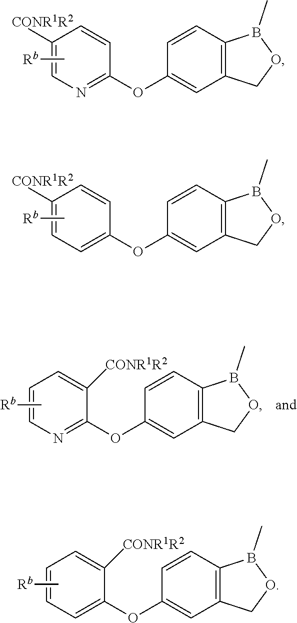

In another embodiment, the volatile compound of the invention is selected from:

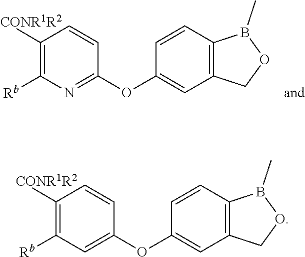

In another embodiment, the volatile compound of the invention is selected from:

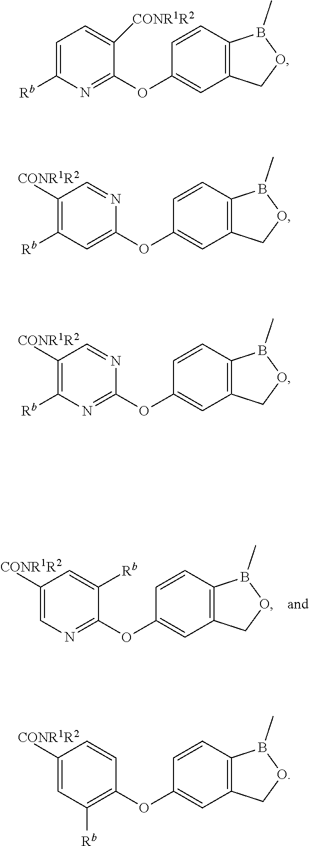

In one embodiment, R^{b} is selected from fluorine and chlorine. In another embodiment, R^{b} is selected from OR²⁰ and NR²¹R²². In another embodiment when R^{b} is OR²⁰, R²⁰ is selected from H, substituted or unsubstituted alkyl, substituted or unsubstituted heteroalkyl, substituted or unsubstituted cycloalkyl, substituted or unsubstituted heterocycloalkyl, substituted or unsubstituted aryl, and substituted or unsubstituted heteroaryl. In another embodiment when R^{b} is OR²⁰, R²⁰ is selected from H, substituted or unsubstituted alkyl, substituted or unsubstituted heteroalkyl and substituted or unsubstituted cycloalkyl. In another embodiment when R^{b} is OR²⁰, R²⁰ is unsubstituted C₁₋₆ alkyl. In another embodiment when R^{b} is OR²⁰, R²⁰ is unsubstituted cycloalkyl. In another embodiment when R^{b} is OR²⁰, R²⁰ is alkyl, substituted with a member selected from substituted or unsubstituted C₁₋₆ alkoxy. In another embodiment when R^{b} is OR²⁰, R²⁰ is alkyl, substituted with at least one halogen. In another embodiment when R^{b} OR²⁰, R²⁰ is alkyl, substituted with at least one oxo moiety.

In another embodiment when R^{b} is OR²⁰, R²⁰ is a member selected from —CH₃, —CH₂CH₃, —(CH₂)₂CH₃, —CH(CH₃)₂, —CH₂CF₃, —CH₂CHF₂, —CH₂CH₂(OH), —CH₂CH₂(OCH₃), —CH₂CH₂(OC(CH₃)₂), —C(O)CH₃, —CH₂CH₂OC(O)CH₃, —CH₂C(O)OCH₂CH₃, —CH₂C(O)OC(CH₃)₃, —(CH₂)₃C(O)CH₃, —CH₂C(O)OC(CH)₃, cyclopentyl, cyclohexyl,

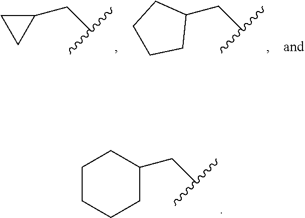

In another embodiment when R^{b} is NR²¹R²², R²¹ and R²² are members independently selected from H, substituted or unsubstituted alkyl, substituted or unsubstituted heteroalkyl, substituted or unsubstituted cycloalkyl, substituted or unsubstituted heterocycloalkyl, substituted or unsubstituted aryl, and substituted or unsubstituted heteroaryl. In another embodiment when R^{b} is NR²¹R²², R²¹ is H or unsubstituted alkyl; and R²² is unsubstituted alkyl or alkyl substituted with a member selected from hydroxyl, phenyl, unsubstituted alkoxy and alkoxy substituted with a phenyl. In a further embodiment when R^{b} is NR²¹R²², R²¹ is H or CH₃.

In another embodiment when R^{b} is NR²¹R²², R²¹ and R²² are independently selected from substituted or unsubstituted alkyl. In another embodiment when R^{b} is NR²¹R²², R²¹ is unsubstituted alkyl; and R²² is substituted or unsubstituted alkyl. In another embodiment when R^{b} is NR²¹R²², R²¹ is unsubstituted alkyl; and R²² is alkyl, substituted with a member selected from substituted or unsubstituted alkoxy and hydroxyl. In another embodiment when R^{b} is NR²¹R²², R²¹ is unsubstituted alkyl; and R²² is alkyl, substituted with unsubstituted alkoxy. In another embodiment when R^{b} is NR²¹R²², R²¹ is unsubstituted alkyl; and R²² is alkyl, substituted with alkoxy, substituted with phenyl. In another embodiment when R^{b} is NR²¹R²², R²¹ is unsubstituted alkyl; and R²² is alkyl, substituted with unsubstituted alkoxy. In another embodiment when R^{b} is NR²¹R²², R²¹ and R²² together with the nitrogen to which they are attached, are combined to form a 4- to 8-membered substituted or unsubstituted heterocycloalkyl ring. In another embodiment when R^{b} is NR²¹R²², R²¹ and R²² together with the nitrogen to which they are attached, are combined to form a 5- or 6-membered substituted or unsubstituted heterocycloalkyl ring.

In another embodiment, R^{b} is selected from N(CH₃)₂, N(CH₃)(CH₂CH₂(OCH₃)), N(CH₃)(CH₂CH₂OH), NH₂, NHCH₃, NH(CH₂CH₂(OCH₃)), NH(CH₂CH₂(OCH₂Ph), NH(CH₂Ph), NH(C(CH₃)₃) and NH(CH₂CH₂OH). In another embodiment, R^{b} is selected from

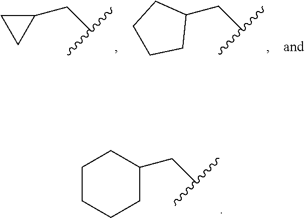

Additional oxaborole moieties are also disclosed previously in U.S. Pat. No. 8,039,450, and patent application publication US 2009/0291917, the contents of which are hereby incorporated by reference in their entireties.

In another embodiment, the volatile compound provided has a structure of formula (A1) or (A2):

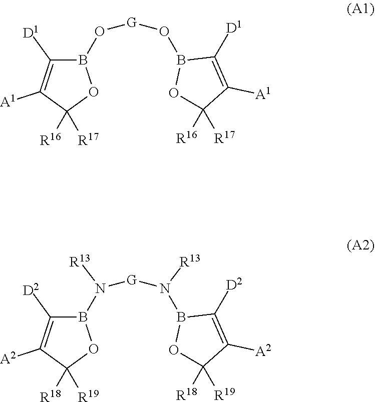

wherein each of A¹, A², D¹, and D² is independently hydrogen, substituted or unsubstituted C₁₋₁₈-alkyl, arylalkyl, aryl, or heterocyclic; or A¹ and D¹, or A² and D² together form a 5, 6, or 7-membered fused ring which is substituted or unsubstituted;

each of R¹³, R¹⁶, R¹⁷, R¹⁸, and R¹⁹ is independently hydrogen, substituted or unsubstituted C₁_6-alkyl, nitrile, nitro, aryl or aryl alkyl; or R¹⁶ and R¹⁷, or R¹⁸ and R¹⁹ together form an alicyclic ring which is substituted or unsubstituted;

B is boron; and

G is a substituted or unsubstituted C₁₋₁₈-alkylene, arylalkylene, arylene, or heterocyclic moiety.

In another embodiment, each of R^{A} and R^{B} is independently

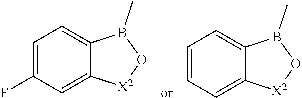

wherein X²═(CR⁶₂)ₘ and m=1, 2, 3, or 4.

In another embodiment, each of R^{A} and R^{B} is independently

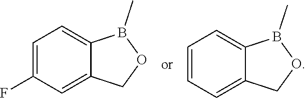

In another embodiment, the volatile compound provided has the structure of

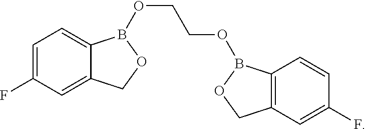 [SMILES: Fc1ccc2c(c1)COB2OCCOB1OCc2cc(F)ccc21]

Additional oxaborole moieties are also disclosed previously in U.S. Pat. No. 5,880,188, the content of which is hereby incorporated by reference in its entirety.

In some embodiments, the volatile compound is present in the formulation at a concentration of about 0.001% to about 1%. In other embodiments, the volatile compound is present in the formulation at a concentration of about 0.01% to about 0.1%. In yet other embodiments, the volatile compound is present in the formulation at a concentration of about 0.02% to about 0.1%. In other embodiments, the volatile compound is present in the formulation at a concentration of about 1% to about 10%. In yet other embodiments, the volatile compound is present in the formulation at a concentration of about 10% to about 30%. In other embodiments, the volatile compound is present in the formulation at a concentration of about 10% to about 60%. In yet other embodiments, the volatile compound is present in the formulation at a concentration of about 30% to about 60%.

In various aspects, the formulation comprises one or more solvents, liquid carriers, liquid media, or any combination thereof. In some embodiments, the one or more solvents, liquid carriers, and liquid media is an alcohol. In other embodiments, the one or more solvents, liquid carriers, and liquid media are selected from the group consisting of a glycol, a polyglycol, or combinations thereof. In yet other embodiments, the one or more solvents, liquid carriers, and liquid media are selected from the group consisting of glycerin, polyols, sugars, water, and any combination thereof.

For instance, an exemplary formulation can comprise about 15% w/w or higher of one or more volatile solvents (e.g., volatile solvents with boiling points of 280° C. or less under normal ambient conditions). The exemplary formulation can be useful for applications involving thermal fogging or thermal atomization processes.

In some instances, the exemplary formulation comprises volatile compound (e.g., an active ingredient) dissolved in one or more water insoluble solvents. The exemplary formulation can comprise surfactants or emulsifiers. The exemplary formulation can be useful to form an emulsion or dispersion upon dilution in water suitable for spray, drench, flood, or dip applications.

In other aspects, the formulation comprises one or more enhancing agents. In some embodiments, the enhancing agents are selected from the group consisting of a spreading agent, an adhesion agent, a surfactant, a stabilizer, a surface tension reducing agent, a dynamic surface tension reducing agent, a rheology modifying agent, and any combination thereof.

In certain aspects, the formulation comprises one or more release modifiers. In some embodiments, the release modifiers are selected from the group consisting of a thickener, a gellant, a polymer, and combinations thereof.

For instance, an exemplary formulation can comprise i) a volatile compound (e.g., an active ingredient) from about 0.01% to about 50%; ii) one or more solvents and carriers (e.g., water, alcohols, esters, amides, glycols, ethers, glycerin, glycol ethers, their polymers, oligomers, other derivatives, and mixtures thereof); iii) optionally, other general functional ingredients to improve the delivery or use characteristics of the formulation (e.g., stabilizers, pH control agents, surfactants (for wetting, dispersing, spreading, emulsifying, adjuvancy, and the like), rheology control agents, biocides, antifoams, and other ingredients known to the skilled artisan. The exemplary formulation can be in the forms of a solution, or n emulsion, or a suspension, or a dispersion, or any combination thereof.

In some instances, the exemplary formulation comprises volatile compound (e.g., an active ingredient) in the form of water soluble salt which can be formed by an acidic active ingredient neutralized by a base such as alkaline metal or alkaline earth metal hydroxides, or carbonate, or bicarbonate, or other metal hydroxides, or carbonate, or bicarbonate, or organic amines, or ammonium hydroxide, or choline hydroxide, or histidine, or arginine, or lysine, or any combinations thereof. Such volatile compound could be formed by basic active ingredients neutralized by an acid such as inorganic acids including but not limited hydrochloride acid, nitric acid, sulfuric acid, or organic acids including but not limited to citric acid, acetic acid, or other carboxylic acid containing molecules. The exemplary formulation can be useful for direct application or for application after further dilution in a form of spray, drench, flood, or dip.

According to certain aspects of the present disclosure, the volatile compound is more uniformly distributed after the step of redistribution. For instance, delivery of the formulation comprising the volatile compound to a first location can result in a non-uniform distribution of the volatile compound at the first location. The volatile compound may thereafter undergo redistribution from the first location to a second location, thus resulting in a more uniform distribution of the volatile compound at the second location. In some embodiments, the uniform distribution is on a surface of the target produce.

Evaluation of the “uniform distribution” can be accomplished according to practices known in the art. In other embodiments, the uniform distribution is identified via residue analysis of the volatile compound.

In certain aspects, delivery of the volatile compound to a first location can result in a concentration of the volatile compound at the first location, referred to as a “first concentration.” Upon redistribution of the volatile compound from the first location to a second location, a “second concentration” of the volatile compound can be present at the second location. In some embodiments, the second concentration is lower than the first concentration.

In various aspects, the step of delivering the volatile compound provides the volatile component at a first mass transfer rate and the step of redistributing provides the volatile component at a second mass transfer rate. In some embodiments, the second mass transfer rate is slower than the first mass transfer rate.

In a second aspect described herein, a method of applying a volatile compound to a target produce comprises the steps of delivering a formulation comprising the volatile compound to a first location, and thereafter redistributing the volatile compound from the first location to a second location, wherein the second location is on a surface of the target produce. The previously described embodiments of the first method of applying a volatile compound to a target produce are applicable to the second method of applying a volatile compound to a target produce described herein.

In the second aspect, the volatile compound is redistributed from the first location to a second location, wherein the second location is on a surface of the target produce. Any spot or a plurality of spots located on the surface of the target can comprise the second location in this described method.

In a third aspect described herein, a method of applying a volatile compound to a target produce comprises the steps of delivering a formulation comprising the volatile compound to a first location, wherein the first location is on a first surface of the target produce and thereafter redistributing the volatile compound from the first location to a second location, wherein the second location is on a second surface of the target produce. The previously described embodiments of the first method of applying a volatile compound to a target produce and of the second method of applying a volatile compound to a target produce are applicable to the third method of applying a volatile compound to a target produce described herein.

In the third aspect, the volatile compound is delivered to a first location, wherein the first location is on a first surface of the target produce. Any spot or a plurality of spots located on the surface of the target can comprise the first surface of the first location in this described method. Thereafter, the volatile compound is redistributed from the first location to a second location, wherein the second location is on a second surface of the target produce. Likewise, any spot or a plurality of spots located on the surface of the target can comprise the second location in this described method as long as it is different than the first location.

### EXAMPLES

The various embodiments of the present disclosure can be evaluated according to the following exemplary factorial design. The instant example can evaluate methods of applying a volatile compound to a target produce, including the steps of delivering a formulation comprising the volatile compound to a first location, and thereafter, and thereafter redistributing the volatile compound from the first location to a second location, wherein the second location is an enclosed space or a partially enclosed space.

A negative control formulation (e.g., an untreated substrate and/or a blank treatment formulation) can be tested for comparison to the evaluated formulations of the present disclosure. In addition, one or more positive control formulations (e.g., using similar experimentation but including commercially available active ingredients such as Fludioxonil, Pyrimethanil, Thiabendazole, or Imazalil) can be tested for comparison to the evaluated formulations of the present disclosure.

Input Parameters

The input parameters for evaluation of the embodiments can include varying the delivery mechanism and the redistribution mechanism of the formulation to be tested. Various substrates can be evaluated, as well as various volatile compounds at differing percentages in the formulation. In addition, other co-ingredients for the formulations can be tested.

Input parameters for exemplary formulations of the present disclosure can be found in the following tables:

TABLE 1
Exemplary Formulation 1

| | |
|---|---|
| Primary | Room fog (e.g., ActiMist) |
| delivery | |
| Secondary | Within bag or case |
| redistribution | |
| Substrate | Grape and/or package |
| Volatile | Benzoxaborole |
| compound | |
| % of volatile | 10-30% |
| compound | |
| Formulation | Non-aqueous soluble liquid |
| Co-ingredients | Basic (glycol/alcohol) + Enhancers (spreading agents, |
| | adhesion agents, atomizing surfactants, etc.) + Release |
| | modifiers (thickeners, gellants, polymers, etc.) + Stabi- |
| | lizers (alpha-hydroxy carboxylic acids, anti-oxidizers, |
| | etc.) |

TABLE 2
Exemplary Formulation 2

| | |
|---|---|
| Primary | Room fog (e.g., ActiMist) |
| delivery | |
| Secondary | Within bin |
| redistribution | |
| Substrate | Apple and/or crate |
| Volatile | Benzoxaborole |
| compound | |
| % of volatile | 10-30% |
| compound | |
| Formulation | Non-aqueous soluble liquid |
| Co-ingredients | Basic (glycol/alcohol) + Enhancers (spreading agents, |
| | adhesion agents, atomizing surfactants, etc.) + Release |
| | modifiers (thickeners, gellants, polymers, etc.) + Stabi- |
| | lizers (alpha-hydroxy carboxylic acids, anti-oxidizers, |
| | etc.) |

TABLE 3
Exemplary Formulation 3

| | |
|---|---|
| Primary | Room fog (e.g., ActiMist) |
| delivery | |
| Secondary | Within case and/or clamshell |
| redistribution | |
| Substrate | Blueberry, strawberry, and/or package |
| Volatile | Benzoxaborole |
| compound | |
| % of volatile | 10-30% |
| compound | |
| Formulation | Non-aqueous soluble liquid |
| Co-ingredients | Basic (glycol/alcohol) + Enhancers (spreading agents, |
| | adhesion agents, atomizing surfactants, etc.) + Release |
| | modifiers (thickeners, gellants, polymers, etc.) + Stabi- |
| | lizers (alpha-hydroxy carboxylic acids, anti-oxidizers, |
| | etc.) |

TABLE 4
Exemplary Formulation 4

| | |
|---|---|
| Primary | Room fog (e.g., ActiMist) |
| delivery | |
| Secondary | Within case and/or pallet |
| redistribution | |
| Substrate | Citrus fruit and/or package |
| Volatile | Benzoxaborole |
| compound | |
| % of volatile | 10-30% |
| compound | |
| Formulation | Non-aqueous soluble liquid |
| Co-ingredients | Basic (glycol/alcohol) + Enhancers (spreading agents, |
| | adhesion agents, atomizing surfactants, etc.) + Release |
| | modifiers (thickeners, gellants, polymers, etc.) + Stabi- |
| | lizers (alpha-hydroxy carboxylic acids, anti-oxidizers, |
| | etc.) |

TABLE 5
Exemplary Formulation 5

| | |
|---|---|
| Primary | In-line spray or fog tunnel |
| delivery | |
| Secondary | Within bag and/or case |
| redistribution | |
| Substrate | Grape and/or package |
| Volatile | Benzoxaborole |
| compound | |
| % of volatile | 0.1-10% |
| compound | |
| Formulation | Non-aqueous soluble liquid or Aqueous soluble liquid |
| Co-ingredients | Basic (glycol/alcohol) + Enhancers (spreading agents, |
| | adhesion agents, atomizing surfactants, etc.) + Release |
| | modifiers (thickeners, gellants, polymers, etc.) + Stabi- |
| | lizers (alpha-hydroxy carboxylic acids, anti-oxidizers, |
| | etc.) |

TABLE 6
Exemplary Formulation 6

| | |
|---|---|
| Primary | In-line spray or fog tunnel |
| delivery | |
| Secondary | Within case and/or clamshell |
| redistribution | |
| Substrate | Blueberry and/or package |
| Volatile | Benzoxaborole |
| compound | |
| % of volatile | 0.1-10% |
| compound | |
| Formulation | Non-aqueous soluble liquid or Aqueous soluble liquid |
| Co-ingredients | Basic (glycol/alcohol) + Enhancers (spreading agents, |
| | adhesion agents, atomizing surfactants, etc.) + Release |
| | modifiers (thickeners, gellants, polymers, etc.) + Stabi- |
| | lizers (alpha-hydroxy carboxylic acids, anti-oxidizers, |
| | etc.) |

TABLE 7
Exemplary Formulation 7

| | |
|---|---|
| Primary | In-line spray or fog tunnel |
| delivery | |
| Secondary | Within package |
| redistribution | |
| Substrate | Citrus fruit, pome, and/or package |
| Volatile | Benzoxaborole |
| compound | |
| % of volatile | 0.1-10% |
| compound | |
| Formulation | Non-aqueous soluble liquid or Aqueous soluble liquid |
| Co-ingredients | Basic (glycol/alcohol) + Enhancers (spreading agents, |
| | adhesion agents, atomizing surfactants, etc.) + Release |
| | modifiers (thickeners, gellants, polymers, etc.) + Stabi- |
| | lizers (alpha-hydroxy carboxylic acids, anti-oxidizers, |
| | etc.) |

TABLE 8
Exemplary Formulation 8

| | |
|---|---|
| Primary | Drench, dip, and/or flood |
| delivery | |
| Secondary | Within pallet, bin, and/or case |
| redistribution | |
| Substrate | Citrus fruit, pome, and/or package |
| Volatile | Benzoxaborole |
| compound | |
| % of volatile | 0.01-0.2% |
| compound | |
| Formulation | Aqueous soluble liquid |
| Co-ingredients | Basic (glycol/alcohol) + Enhancers (spreading agents, |
| | adhesion agents, atomizing surfactants, etc.) + Release |
| | modifiers (thickeners, gellants, polymers, etc.) + Stabi- |
| | lizers (alpha-hydroxy carboxylic acids, anti-oxidizers, |
| | etc.) |

TABLE 9
Exemplary Formulation 9

| | |
|---|---|
| Primary | Drench, dip, and/or flood |
| delivery | |
| Secondary | Within bag and/or case |
| redistribution | |
| Substrate | Cherry and/or package |
| Volatile | Benzoxaborole |
| compound | |
| % of volatile | 0.02-0.1% |
| compound | |
| Formulation | Aqueous soluble liquid |
| Co-ingredients | Basic (glycol/alcohol) + Enhancers (spreading agents, |
| | adhesion agents, atomizing surfactants, etc.) + Release |
| | modifiers (thickeners, gellants, polymers, etc.) + Stabi- |
| | lizers (alpha-hydroxy carboxylic acids, anti-oxidizers, |
| | etc.) |

TABLE 10
Exemplary Formulation 10

| | |
|---|---|
| Primary | Pallet fog |
| delivery | |
| Secondary | Within pallet and/or case |
| redistribution | |
| Substrate | Cherry, grape, berry fruit, and/or package |
| Volatile | Benzoxaborole |
| compound | |
| % of volatile | 10-30% |
| compound | |
| Formulation | Non-aqueous soluble liquid |
| Co-ingredients | Basic (glycol/alcohol) + Enhancers (spreading agents, |
| | adhesion agents, atomizing surfactants, etc.) + Release |
| | modifiers (thickeners, gellants, polymers, etc.) + Stabi- |
| | lizers (alpha-hydroxy carboxylic acids, anti-oxidizers, |
| | etc.) |

Output Parameters

The output parameters for evaluation of the embodiments can include testing of:
i) Initial atomization of the volatile compound upon primary delivery;
ii) Initial deposition of the volatile compound upon primary delivery;
iii) Initial coverage uniformity of the volatile compound upon primary delivery;
iv) Rate and/or mobility of the volatile compound via redistribution from a first location to a second location;
v) Endpoint coverage uniformity of the volatile compound following redistribution;
vi) Endpoint coverage of the volatile compound within a package or enclosure following redistribution; and
vii) Percentage of decay of the volatile compound over time.

The output parameters can be evaluated according to the following means or by a method known to the skilled artisan:

TABLE 11

| | |
|---|---|
| Initial | Sympatec drop size distribution |
| atomization | |
| Initial | Microscopic visualization, or visual evaluation using |
| deposition | dye |
| Initial coverage | Produce surfaces, pedicels, locations via color |
| uniformity | indicator or residue analysis of volatile compound |
| Rate and/or | Rate of residue loss or gain of the volatile com- |
| mobility of the | pound over time |
| volatile compound | |
| via redistribution | |
| Endpoint coverage | Residue variation of the volatile compound across |
| uniformity | plants or plant parts |
| Endpoint coverage | Residue variation of the volatile compound across |
| within a package | plants or plant parts within the package or enclosure |
| or enclosure | |
| % decay of the | Decay rating of the volatile compound across plants |
| volatile compound | or plant parts |
| over time | |

### Example 1

### Exemplary Preparation Process

The formulation or composition comprising the volatile compound can be prepared, amongst other methods, according to the following exemplary example.

First, one or more solvents or liquid carriers, with optionally functional ingredients, can be combined to achieve a consistent mixture followed by combination with one or more active ingredients. Thereafter, the prepared combination can be mixed, or dissolved, or agitated, or homogenized, or milled to a desired consistency.

In addition, the active ingredients may be dissolved in the liquid carriers to form a clear solution. For instance, the active ingredients may be suspended or dispersed in the liquid carriers to form a consistent dispersion. In some embodiments, the active ingredients may be neutralized and dissolved in an aqueous carrier to form a clear solution. In some embodiments, the active ingredient may be dissolved in one or more hydrophobic solvents and then added into aqueous phase to form a consistent oil in water emulsion.

A person skilled in the art can first prepare a concentrated composition comprising an active ingredient at higher concentration (e.g., from 1-50% by weight, or from 5-50% by weight, or from 10-40% by weight, etc.) with a remaining balance of solvents and other functional ingredients. Such concentrated composition can optionally be further diluted by the end user before applying to the intended crops, or can be directly applied depending on the desired use rates, user practices, or conventions known to those skilled in the art.

### Example 2

### Thermal Fogging Treatment of Red Delicious Apples

The instant example utilizes 5-fluoro-1-hydroxy-3H-2,1-benzoxaborole (CAS #174671-46-6) as the exemplary volatile compound.

The instant example was conducted by 1) setting up a 4 m³ rectangular plastic tent, 2) placing about 500 lbs of red delicious apples in stacked plastic boxes, 3) preparing a foggable formulation by dissolving the volatile compound into a solvent mixture containing 50% w/w propylene glycol, 49.8% w/w isopropyl alcohol, and 0.2% of citric acid to achieve about 30% w/w volatile compound, 4) applying the formulation through a thermal fogger with set temperature at 200° C. and flow rate of about 70 ml/min, 5) storing the apples under refrigerated condition of about 40° F. or 4.4° C. after treatment for observation and residue analysis.

The residue analysis was performed by 1) homogenizing apples with a blender or food processor into a puree, 2) taking 15 g of puree and adding 15 ml ethyl acetate and QuEChERS Salt (Agilent), 3) thoroughly mixing and agitating the mixture, 4) centrifuging the mixture to allow separation of the supernatant or the extract from the fruit puree or matrix, 5) analyzing the extract for volatile compound residue with a LCMS (6470A Triple Quadrupole LC/MS from Agilent).

TABLE 12
Volatile compound residue over time during storage

| | | Residue found on the |
|---|---|---|
| | Average | untreated apples mixed with the |
| Time | residue | treated apples during storage |
| (days) | (mg/kg) | (mg/kg) |
| 0 | 2.971 | N/A |
| 9 | 1.745 | N/A |
| 52 | 1.887 | 0.166 |
| 94 | 1.205 | 0.452 |

The untreated apples were added to the treated apple storage at 40 days after treatment. As shown in Table 12, the untreated apples received volatile compound and accumulate during storage over time, which indicated the fruits that might not be treated or lack of sufficient treatment due to imperfect applications would be protected or receive better protection due to the secondary redistributions of the volatile compound.

### Example 3

### Thermal Fogging Treatment of Blueberries

The instant example utilizes 5-fluoro-1-hydroxy-3H-2,1-benzoxaborole (CAS #174671-46-6) as the exemplary volatile compound.

The experiment was conducted by 1) setting up a 4.3 m³ rectangular plastic tent, 2) placing blueberries in open clamshells in the tent, 3) preparing a foggable formulation by dissolving volatile compound into a solvent mixture containing 50% w/w propylene glycol, 47.8% w/w isopropyl alcohol, 2% w/w sorbitan mono-oleate, and 0.2% of citric acid to achieve about 10% w/w volatile compound, 4) inoculating the blueberries before treatment, 5) applying the formulation through a thermal fogger with set temperature at 200° C. and flow rate of about 70 ml/min, and target use rate of 10 mg active ingredient per kg of blueberries, and 6) storing the blueberries under refrigerated condition of about 4° C. after treatment, and at room temperature to incubate for observation of disease infections.

TABLE 13
B. cinerea infection assessment for blueberries

| | |
|---|---|
| | Untreated blueberries |
| Untreated blueberries | placed adjacent to |
| isolated in storage | treated blueberries |

| Time | B. cinerea | B. cinerea | B. cinerea | B. cinerea |
|---|---|---|---|---|
| (days) | incidence | severity | incidence | severity |
| 4 | 12.6% | 3.1% | 2.6% | 0.2% |
| 13 | 35.6% | 17.1% | 19.2% | 10.6% |

B. cinerea (Botrytis cinerea or Gray mold) infection was assessed at 4 and 13 days incubation time for both untreated blueberries in isolation and untreated blueberries placed adjacent to the treated blueberries one day after the treatment. As shown in Table 13, the untreated blueberries placed adjacent to the treated blueberries have lower disease incidence and severity than those untreated blueberries placed in isolation, which indicated the blueberries that received insufficient or no treatment of volatile compound during the applications can be protected by the secondary redistribution approach described herein.

### Example 4

### Thermal Fogging Treatment of Blueberries

The instant example utilizes 5-fluoro-1-hydroxy-3H-2,1-benzoxaborole (CAS #174671-46-6) as the exemplary volatile compound.

The experiment was conducted by 1) setting up a 4.3 m³ rectangular plastic tent, 2) placing blueberries in open clamshells in the tent, 3) preparing a foggable formulation by dissolving volatile compound into a solvent mixture containing 50% w/w propylene glycol, 47.8% w/w isopropyl alcohol, 2% w/w sorbitan mono-oleate, and 0.2% of citric acid to achieve about 10% w/w volatile compound, 4) inoculating the blueberries before treatment, 5) applying the formulation through a thermal fogger with set temperature at 200° C. and flow rate of about 70 ml/min, and target use rate of 10 mg active ingredient per kg of blueberries, and 6) storing the blueberries under refrigerated condition of about 4° C. after treatment, and at room temperature to incubate for observation of disease infections.

TABLE 14
B. cinerea infection assessment for blueberries

| | | | Untreated blueberries | | | |
|---|---|---|---|---|---|---|
| | Untreated | | placed adjacent to | | | |
| | blueberries | | treated blueberries 6 | | | |
| | isolated in storage | | days after treatment | | Treated blueberries | |
| Time | B. cinerea | B. cinerea | B. cinerea | B. cinerea | B. cinerea | B. cinerea |
| (days) | incidence | severity | incidence | severity | incidence | severity |
| 13 | 23.4% | 10.8% | 16.7% | 4.7% | 2.8% | 1.1% |
| 16 | 25.0% | 13.8% | 23.0% | 6.2% | 2.8% | 1.1% |
| 24 | 31.3% | 25.2% | 33.3% | 15.0% | 5.6% | 3.3% |

B. cinerea infection was assessed at 13, 16, and 24 days incubation time under room temperature shelf life conditions for both untreated blueberry in isolation, untreated blueberry placed adjacent to the treated blueberry six days after the treatment, and the treated blueberries. As shown in Table 14, the untreated blueberries placed adjacent to the treated blueberries have lower disease incidence and severity than those untreated blueberries placed in isolation, which indicated the blueberries that received insufficient or no treatment during the applications can be protected by the secondary redistribution approach described herein.

### Example 5

### Dipping Treatment of Strawberries

The instant example utilizes 5-fluoro-1-hydroxy-3H-2,1-benzoxaborole (CAS #174671-46-6) as the exemplary volatile compound.

The experiment was conducted by 1) preparing a dipping treatment solution by dissolving volatile compound into 20% v/v isopropanol water solution to achieve 10 ppm concentration, 2) pre-inoculate all the strawberries before treatment, 3) dipping strawberries in the prepared solution for 30 seconds, 4) storing the strawberries under refrigerated conditions and at room temperature to incubate for disease observations.

TABLE 15
B. cinerea infection assessment for strawberries

| | | Untreated | |
|---|---|---|---|
| | Untreated | strawberries | |
| | strawberries | placed adjacent | |
| | isolated | to treated | Treated |
| | in storage | strawberries | strawberries |
| Time | B. cinerea | B. cinerea | B. cinerea |
| (days) | severity | severity | severity |
| 3 | 17.3% | 5.4% | 0.0% |
| 5 | 94.0% | 43.8% | 0.0% |

B. cinerea infection was assessed at 3 and 5 days incubation time for both untreated strawberries in isolation and untreated strawberries placed adjacent to the treated strawberries. As shown in Table 15, the untreated strawberries placed adjacent to the treated strawberries have lower disease severity than those untreated but placed in isolation, which indicated the strawberries that received insufficient or no treatment of volatile compound during the applications can be protected by the secondary redistribution approach described herein.

### Example 6

### Dipping Treatment of Mandarins

The instant example utilizes 5-fluoro-1-hydroxy-3H-2,1-benzoxaborole (CAS #174671-46-6) as the exemplary volatile compound.

The experiment was conducted by 1) preparing a dipping treatment solution by diluting 360 ml concentrated formulation containing 10% w/w volatile compound, 45% w/w propylene glycol, 43.02% w/w isopropanol, 1.8% w/w sorbitan mono-oleate, 0.18% w/w citric acid into 60 L water, 2) dipping a box of mandarins into the treatment solution bath for about 60 seconds, 3) after air drying of the mandarins, preparing a box of mandarins containing 50% untreated mandarins and 50% treated mandarins, 4) storing the mandarins under 3-5° C. refrigerated conditions for 7 days, and then storing at room temperature with high humidity to incubate for disease observations.

TABLE 16
Penicillium Digitatum (Green mold) and Penicillium italicum
(Blue mold) infection assessment for mandarins

| | Untreated mandarins | Equally mixed mandarins |
|---|---|---|
| | isolated in storage | of untreated and treated |
| Time | Green and Gray molds | Green and Gray |
| (days) | incidence | molds incidence |
| 10 | 6.4% | 4.1% |

Penicillium digitatum (Green mold) and Penicillium italicum (Blue mold) infection incidence of the mandarins was assessed at 10 days incubation time under room temperature shelf life conditions for both untreated mandarins in isolation and equally mixed untreated and treated mandarins to simulate uneven drench or dip treatment applications. As shown in Table 16, the box of equally mixed mandarins demonstrated lower overall mold incidence than those untreated mandarins placed in isolation, which indicated the mandarins that received insufficient or no treatment during the applications can be protected by the secondary redistribution approach described herein.

The residues of volatile compound was also analyzed for the mandarins of initial untreated and treated fruits as well as the untreated fruits mixed with the treated fruits during cold storage to simulate insufficient coverage of initial dipping or drenching treatment applications. As shown in Table 17, the untreated mandarins received volatile compound during the cold storage over time, which indicated the mandarins that might not be treated or lack of sufficient treatment due to imperfect applications would be protected or better protected due to the secondary redistributions of the active ingredient.

TABLE 17
Volatile compound residue over time during cold storage

| | Residue on | Residue on | |
|---|---|---|---|
| Time | untreated | untreated | Residue on |
| in cold | mandarins in | mandarins mixed with | treated |
| storage | isolation | treated mandarins | mandarins |
| (days) | (mg/kg) | (mg/kg) | (mg/kg) |
| 0 | Non-detectable | Non-detectable | 0.877 |
| 3 | Not analyzed | 0.400 | 1.168 |
| 7 | Not analyzed | 0.403 | 1.182 |

### Example 7

### Spray Treatment of Mandarins

The instant example utilizes 5-fluoro-1-hydroxy-3H-2,1-benzoxaborole (CAS #174671-46-6) as the exemplary volatile compound.

The experiment was conducted by 1) preparing a spray treatment solution by diluting 6 nil concentrated formulation containing 10% w/w volatile compound, 45% w/w propylene glycol, 43.02% w/w isopropanol, 1.8% w/w sorbitan mono-oleate, 0.18% w/w citric acid into 1 L water, 2) spraying a box of mandarins with the use rate of 60 ml treatment solution per box, 3) after air drying of the mandarins, preparing a box of mandarins containing 50% untreated mandarins and 50% treated mandarins, 4) storing the mandarins under 3-5° C. refrigerated conditions for 7 days, and then storing at room temperature with high humidity to incubate for disease observations.

TABLE 18
Penicillium Digitatum (Green mold) and Penicillium italicum
(Blue mold) infection assessment for mandarins

| | Untreated mandarins | Equally mixed mandarins |
|---|---|---|
| | isolated in storage | of untreated and treated |
| Time | Green and Gray molds | Green and Gray |
| (days) | incidence | molds incidence |
| 10 | 0.97% | 0.64% |

Penicillium Digitatum (Green mold) and Penicillium italicum (Blue mold) infection incidence of the mandarins was assessed at 10 days incubation time under room temperature shelf life conditions for both untreated mandarins in isolation and equally mixed untreated and treated mandarins to simulate uneven spray treatment applications. As shown in Table 18, the box of equally mixed mandarins demonstrated lower overall mold incidence than those untreated mandarins placed in isolation, which indicated the mandarins that received insufficient or no treatment during the applications can be protected by the secondary redistribution approach described herein.

The residues of volatile compound was also analyzed for the mandarins of initial untreated and treated fruits as well as the untreated fruits mixed with the treated fruits during cold storage to simulate insufficient coverage of initial spray treatment applications. As shown in Table 19, the untreated mandarins received volatile compound during the cold storage over time, which indicated the mandarins that might not be treated or lack of sufficient treatment due to imperfect spray applications would be protected or better protected due to the secondary redistributions of the active ingredient.

TABLE 19
Volatile compound residue over time during cold storage

| | | Residue on | | Relative |
|---|---|---|---|---|
| | Residue on | untreated | | standard |
| Time | untreated | mandarins mixed | Residue on | deviation |
| in cold | mandarins in | with treated | treated | of residue |
| storage | isolation | mandarins | mandarins, | on treated |
| (days) | (mg/kg) | (mg/kg) | mg/kg | mandarin, % |
| 0 | Non-detectable | Non- | 0.649 | 40.9% |
| | | detectable | | |
| 3 | Not analyzed | 0.239 | 0.505 | 11.2% |
| 7 | Not analyzed | 0.190 | 0.278 | 18.1% |

What is claimed is:

1. A method of applying a volatile compound to a target produce, said method comprising the steps of:
A. delivering a formulation comprising the volatile compound to a first location, and thereafter
B. redistributing the volatile compound from the first location to a second location.

2. The method of claim 1, wherein the second location is on a surface of the target produce.

3. The method of claim 1, wherein the first location is on a first surface of the target produce and wherein the second location is on a second surface of the target produce.

4. The method of claim 1, wherein the step of delivering is selected from the group consisting of spraying, misting, thermal or non-thermal fogging, drenching, dipping, submersing, and combinations thereof.

5. The method of claim 1, wherein the step of delivering comprises spraying.

6. The method of claim 5, wherein the spraying is selected from the group consisting of electrostatic spraying, electrospraying, pneumatic air spraying, compressed air spraying, ultrasonic air spraying, air assisted ultrasonic air spraying, and combinations thereof.

7. The method of claim 1, wherein the step of delivering comprises fogging.

8. The method of claim 7, wherein the fogging is selected from the group consisting of thermo fogging, thermal fogging, cold fogging, nebulizing, misting, air brushing, and combinations thereof.

9. The method of claim 1, wherein the step of delivering comprises a continuous liquid application selected from the group consisting of a drench, a dip, a submersion, a flooding, a curtain shower, and combinations thereof.

10. The method of claim 1, wherein the first location is a composition located within about 1 meter of the target produce.

11. The method of claim 1, wherein the first location is selected from the group consisting of a package, a container, a pallet, a bin, a bag, a case, a clamshell, and a composition located near the target produce.

12. The method of claim 1, wherein the second location is selected from the group consisting of a storage room, a package, a container, a pallet, a bin, a bag, a case, a clamshell, and a composition located near the target produce.

13. The method of claim 1, wherein the step of delivering provides the volatile compound to a first percentage of available surface area coverage and the step of redistributing provides the volatile compound to a second percentage of available surface area coverage that is greater than the first percentage of available surface area coverage.

14. The method of claim 1, wherein the formulation comprises the volatile compound at a vapor pressure of about 10⁻⁵ torr at 1 atm/25° C. to about 10⁻³ torr at 1 atm/25° C.

15. The method of claim 1, wherein the volatile compound is a benzoxaborole.

16. The method of claim 1, wherein the volatile compound has a structure of

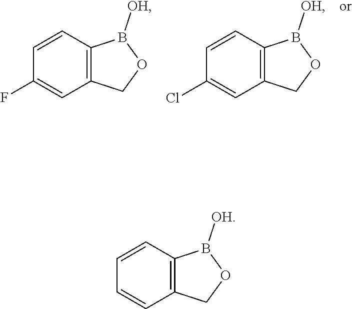 [SMILES: OB1OCc2cc(F)ccc21 ; OB1OCc2cc(Cl)ccc21 ; OB1OCc2ccccc21]

17. The method of claim 1, wherein the volatile compound is more uniformly distributed after the step of redistribution.

18. The method of claim 17, wherein the uniform distribution is on a surface of the target produce.

19. The method of claim 1, wherein the volatile component comprises a first concentration at the first location and a second concentration at the second location, wherein the second concentration is lower than the first concentration.

20. The method of claim 1, wherein the step of delivering provides the volatile component at a first mass transfer rate and the step of redistributing provides the volatile component at a second mass transfer rate, wherein the second mass transfer rate is slower than the first mass transfer rate.
